(19) United States
(12) Patent Application Publication
(10) Pub. No.: US 2026/0262034 A1
(43) Pub. Date: Sep. 3, 2026

(54) TIME SCHEDULE-BASED PARAMETERS FOR WIRELESS COMMUNICATION

(71) Applicant: QUALCOMM Incorporated, San Diego, CA (US)

(72) Inventors: Narayan PRASAD, Westfield, NJ (US); Tao LUO, San Diego, CA (US); Sony AKKARAKARAN, Poway, CA (US); Junyi LI, Greentown, PA (US)

(21) Appl. No.: 19/069,050

(22) Filed: Mar. 3, 2025

(51) Int. Cl. H04W 72/1263; H04W 72/0446

(52) U.S. Cl. CPC H04W 72/1263; H04W 72/0446

(57) ABSTRACT

Aspects relate to time schedule based parameters. For example, a wireless communication device may receive a message including a parameter set with an associated time schedule. In some aspects the message may indicate a mapping of each of a plurality of time periods of the time schedule with a corresponding subset of the parameter set. For example, a first subset of the parameter set may include one or more parameters to be used for a transmission that is to occur during a first time period of the plurality of time periods. The wireless communication device may thus transmit a transmission based on at least one parameter of the parameter set.

### TECHNICAL FIELD

The technology discussed below relates generally to wireless communication and, more particularly, to techniques for using time schedule-based parameters to, for example, improve coexistence among wireless communication devices.

### INTRODUCTION

Some types of wireless communication systems support communication via one or more cells. For example, a base station that is connected to a network may serve (e.g., provide access to the network and/or other service for) a wireless communication device such as a user equipment (UE) operating within a cell (e.g., corresponding to a wireless communication coverage area) of the base station. To this end, the base station may schedule wireless communication access within the cell by, for example, allocating resources (e.g., time domain and frequency domain resources) that a UE operating within the cell can use to transmit and receive wireless signals.

Other types of wireless communication systems may operate in a similar manner where a first wireless communication device connected to a network provides network access and/or other service for other wireless communication devices within a coverage area of the first wireless communication device. For example, a satellite that connects to a terrestrial network (e.g., via a ground-based gateway) may serve a user terminal that is within the wireless communication coverage area of the satellite. As another example, a customer premise equipment that connects to a network (e.g., via wireless signaling) may serve wired or wireless communication devices within a local network.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first wireless communication device may include one or more memories storing processor-executable code and one or more processors. The one or more processors may be configured to execute the processor-executable code and cause the first wireless communication device to receive a first message comprising a first parameter set and associated first time schedule, the first message indicating a mapping of each of a plurality of time periods of the first time schedule with a corresponding subset of the first parameter set. The one or more processors may also be configured to execute the processor-executable code and cause the first wireless communication device to transmit a first transmission based on at least one parameter of the first parameter set.

In some examples, a method for wireless communication at a first wireless communication device is disclosed. The method may include receiving a first message comprising a first parameter set and associated first time schedule, the first message indicating a mapping of each of a plurality of time periods of the first time schedule with a corresponding subset of the first parameter set. The method may also include transmitting a first transmission based on at least one parameter of the first parameter set.

In some examples, a first wireless communication device may include means for receiving a first message comprising a first parameter set and associated first time schedule, the first message indicating a mapping of each of a plurality of time periods of the first time schedule with a corresponding subset of the first parameter set. The user equipment may also include means for transmitting a first transmission based on at least one parameter of the first parameter set.

In some examples, a non-transitory computer-readable medium has stored therein instructions executable by one or more processors of a first wireless communication device to receive a first message comprising a first parameter set and associated first time schedule, the first message indicating a mapping of each of a plurality of time periods of the first time schedule with a corresponding subset of the first parameter set. The computer-readable medium may also have stored therein instructions executable by one or more processors of the first wireless communication device to transmit a first transmission based on at least one parameter of the first parameter set.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a block diagram illustrating an example of a wireless communication system supporting beamforming communication according to some aspects.

FIG. 6 is a diagram illustrating an example of communication between a radio access network (RAN) node and a wireless communication device using beamforming according to some aspects.

FIG. 7 is a conceptual illustration of an example of coexistence issues between networks according to some aspects.

FIG. 8 is a conceptual illustration of another example of coexistence issues between networks according to some aspects.

FIG. 9 is a conceptual illustration of another example of coexistence issues between networks according to some aspects.

FIG. 10 is a schematic illustration of transmit chain components according to some aspects.

FIG. 11 is a conceptual illustration of examples of radio frequency radiation patterns according to some aspects.

FIG. 12 is a signaling diagram illustrating an example of coexistence related signaling according to some aspects.

FIG. 13 is a signaling diagram illustrating another example of coexistence related signaling according to some aspects.

FIG. 14 is a signaling diagram illustrating another example of coexistence related signaling according to some aspects.

FIG. 15 is a signaling diagram illustrating another example of coexistence related signaling according to some aspects.

FIG. 16 is a block diagram conceptually illustrating an example of a hardware implementation for a wireless communication device (e.g., a user equipment, a customer premises equipment, etc.) employing a processing system according to some aspects.

FIG. 17 is a flow chart illustrating an example of a communication method involving signaling communication parameters according to some aspects.

FIG. 18 is a flow chart illustrating an example of a communication method involving signaling communication parameters according to some aspects.

FIG. 19 is a block diagram conceptually illustrating an example of a hardware implementation for a wireless communication device (e.g., a network entity) employing a processing system according to some aspects.

FIG. 20 is a flow chart illustrating an example of a communication method involving signaling a parameter set and associated time schedule according to some aspects.

FIG. 21 is a flow chart illustrating an example of a communication method involving signaling a parameter set and associated time schedule according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

In some scenarios, different wireless communication networks may transmit and/or receive signals over the same or substantially the same wireless communication resources. For example, a satellite network may use certain radio frequency (RF) bands for communication with access terminals. In addition, a network entity (e.g., a base station) of a terrestrial network (e.g., a 5G or 6G network) may use at least a portion of these bands and/or adjacent bands for communication with UEs and/or other devices. As another example, a customer premises equipment (CPE), a relay device, or some other similar type of device may communicate with other devices using at least a portion of the bands and/or adjacent bands that are used by a satellite and/or a network entity.

If the devices of different types of networks are sufficiently close to one another, a device in one network may receive signals transmitted by a device in the other network. This scenario may be referred to as wireless communication coexistence (or simply, coexistence). In some cases, such signaling may result in unwanted interference at a device. For example, if a satellite of a satellite network is relatively close to a device operating in a terrestrial network, transmissions by a terrestrial device (e.g., a network entity, a user equipment, a CPE, etc.) may interfere with receive operations at the satellite. As another example, if a CPE or relay device is relatively close to a transmitting device operating in a nearby network, transmissions by the transmitting device (e.g., a network entity, etc.) may interfere with receive operations at the CPE or relay device.

The disclosure relates in some aspects to techniques for facilitating effective coexistence between devices operating in different networks or sub-networks. For example, provisions may be made such that the transmissions by a device in one network are adapted in an attempt to ensure that the transmissions by that device do not unduly interfere with receive operations at a device in another network or sub-network.

Various aspects of the disclosure relate to using time schedule-based parameters to facilitate coexistence. For example, a wireless communication device may receive (e.g., from a network node) a message including a parameter set and an associated time schedule. In some aspects, the message may indicate a mapping of each of a plurality of time periods of the time schedule with a corresponding subset of the parameter set. For example, a first subset of the parameter set may include one or more parameters to be used for a first transmission that is to occur during a first time period of the plurality of time periods, a second subset of the parameter set may include one or more parameters to be used for a second transmission that is to occur during a second time period of the plurality of time periods, and so on. The wireless communication device may thus transmit a transmission based on at least one parameter of the parameter set.

In some examples, the parameter set corresponds to one or more time varying coexistence constraints. For example, such a constraint may indicate a maximum interference level that transmissions by a device in a first network are allowed to cause at a device in a second network (e.g., over a certain period of time).

In some examples, the parameter set may include parameters that a device may use to estimate the amount of interference caused at another device or meet an interference requirement. For example, the parameter set may specify angular coordinates and/or the distance between the devices at designated periods of time. As another example, the parameter set may indicate a maximum transmit power for an interfering device.

In some examples, a first device that receives the parameter set may determine one or more communication parameters to be used at the first device or a second device (e.g., a device that is served by the first device). For example, the first device may calculate, based on time varying coexistence constraints, one or more of: a wireless communication setting, a wireless communication attribute, a beamforming mode, a beamformer, a beamforming codebook, an antenna array, antenna element tilt information, an antenna radiation pattern, a transmit power, a bandwidth, and so on.

In some examples, a device may perform certain operations based on such communication parameters. For example, a device may perform one or more of: switching from a digital beamforming mode to an analog beamforming mode, switching from an analog beamforming mode to a digital beamforming mode, switching from a first beamforming codebook to a second beamforming codebook, switching from a first beamformer (e.g., the use of analog beamformer circuitry) to a second beamformer (e.g., the use of digital beamformer circuitry), switching from a first precoder (e.g., [1,1]^{T} as a basic example) to a second precoder (e.g., [1, j]^{T} as a basic example), adjusting a transmit power, switching from a first transmit bandwidth to a second transmit bandwidth, enabling an antenna (e.g., an antenna panel) or an antenna element, disabling an antenna or an antenna element, adjusting a tilt of an antenna or an antenna element, or adjusting a radiation pattern of an antenna or an antenna element.

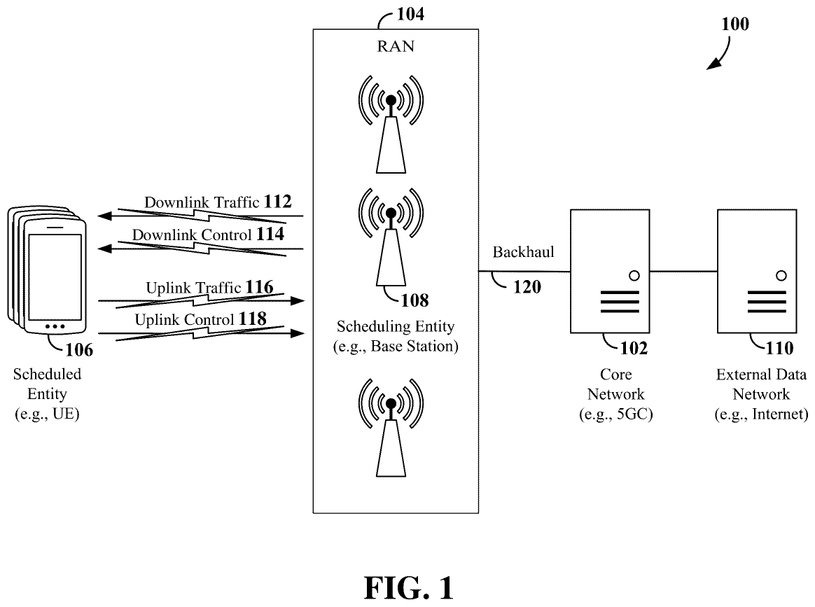

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

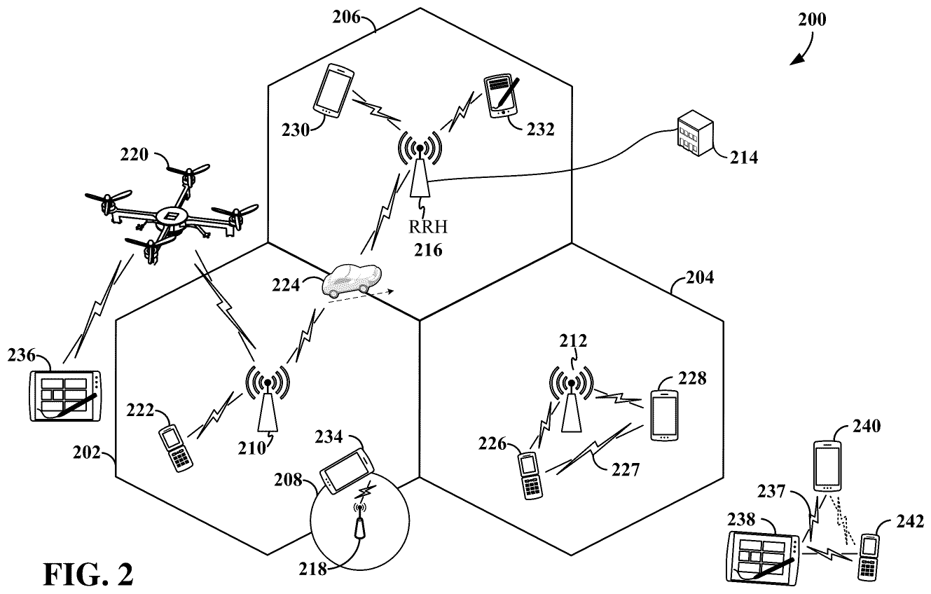

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

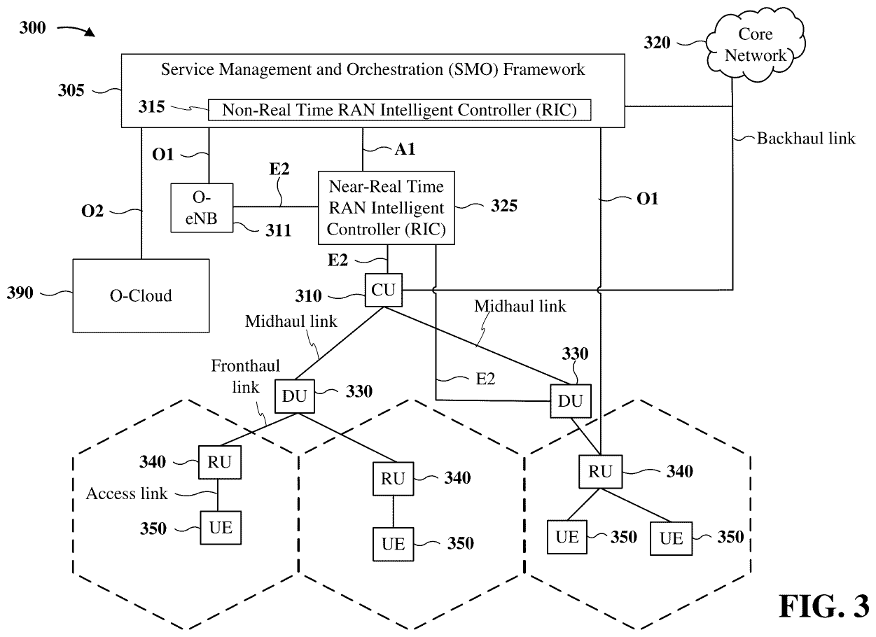

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

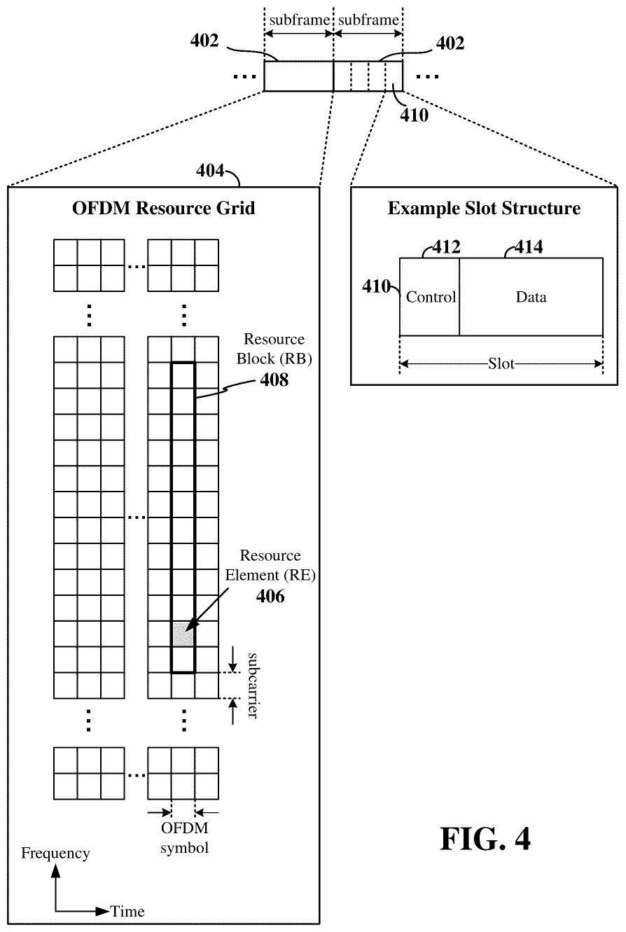

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier ×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

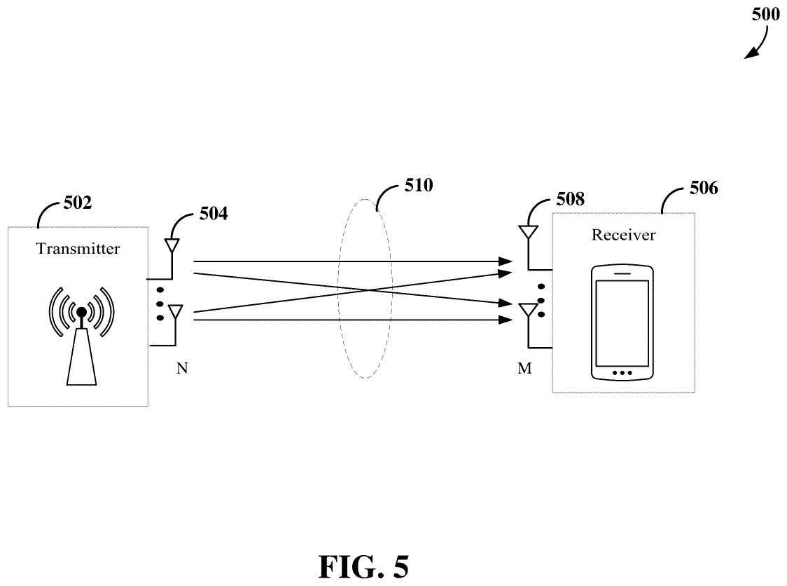

Wireless communication devices (e.g., network entities, UEs, CPEs, relay devices, and so on) may be configured for beamforming and/or multiple-input multiple-output (MIMO) technology. FIG. 5 illustrates an example of a wireless communication system 500 supporting beamforming and/or MIMO. In the wireless communication system 500, a transmitter 502 includes multiple transmit antennas 504 (e.g., N transmit antennas) and a receiver 506 includes multiple receive antennas 508 (e.g., M receive antennas). Thus, there are N×M signal paths 510 from the transmit antennas 504 to the receive antennas 508. Each of the transmitter 502 and the receiver 506 may be implemented, for example, within a network entity, a UE, a CPE, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the network entity to identify the source of each spatially precoded data stream.

The number of data streams or layers (e.g., MIMO layers) corresponds to the rank of the transmission. In general, the rank of the wireless communication system 500 (e.g., a MIMO system) is limited by the number of transmit antenna 504 or receive antennas 508, whichever is lower. In addition, the channel conditions at the UE, as well as other considerations, such as the available resources at the network entity, may also affect the transmission rank. For example, the rank (and therefore, the number of data streams) assigned to a particular UE on the downlink may be determined based on the rank indicator (RI) transmitted from the UE to the network entity. The RI may be determined based on the antenna configuration (e.g., the number of transmit and receive antennas) and a measured signal-to-interference-plus-noise ratio (SINR) on each of the receive antennas. The RI may indicate, for example, the number of layers that may be supported under the current channel conditions. The network entity may use the RI, along with resource information (e.g., the available resources and amount of data to be scheduled for the UE), to assign a transmission rank to the UE.

In one example (e.g., FIG. 5), a rank-2 spatial multiplexing transmission on a 2×2 MIMO antenna configuration will transmit one data stream from each transmit antenna 504. Each data stream reaches each receive antenna 508 along a different signal path 510. The receiver 506 may then reconstruct the data streams using the received signals from each receive antenna 508.

Beamforming is a signal processing technique that may be used at the transmitter 502 or the receiver 506 to shape or steer an antenna beam (e.g., a transmit beam or receive beam) along a spatial path between the transmitter 502 and the receiver 506. Beamforming may be achieved by combining the signals communicated via the transmit antennas 504 or the receive antennas 508 (e.g., antenna elements of an antenna array module) such that some of the signals experience constructive interference while others experience destructive interference. To create the desired constructive/destructive interference, the transmitter 502 or the receiver 506 may apply amplitude and/or phase offsets to signals transmitted from each of the transmit antennas 504 or received by each of the receive antenna 508.

In 5G New Radio (NR) systems, particularly for above 6 GHz or mmWave systems, beamformed signals may be utilized for most downlink channels, including the physical downlink control channel (PDCCH) and physical downlink shared channel (PDSCH). In addition, broadcast control information, such as the SSB, slot format indicator (SFI), and paging information, may be transmitted in a beam-sweeping manner to enable all scheduled entities (UEs) in the coverage area of a transmission and reception point (TRP) (e.g., a gNB) to receive the broadcast control information. In addition, for UEs configured with beamforming antenna arrays, beamformed signals may also be utilized for uplink channels, including the physical uplink control channel (PUCCH) and physical uplink shared channel (PUSCH).

A network entity (e.g., gNB) may generally be capable of communicating with UEs using beams (e.g., downlink transmit beams) of varying beam widths. For example, a network entity may be configured to utilize a wider beam when communicating with a UE that is in motion and a narrower beam when communicating with a UE that is stationary.

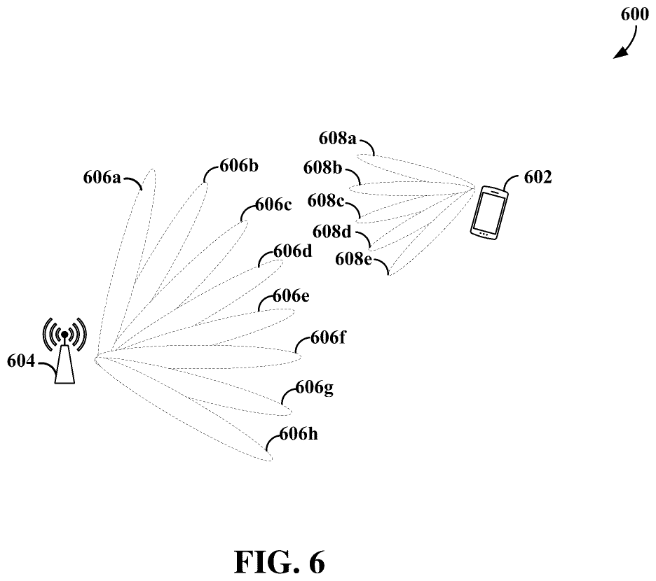

FIG. 6 is a diagram illustrating communication between a network entity 604 and a UE 602 using beamformed signals according to some aspects. The network entity 604 may be any of the network entities (e.g., gNBs), CUs, DUs, RUs, or scheduling entities illustrated in any of FIGS. 1-25. The UE 602 may be any of the UEs, CPEs, relay devices, or scheduled entities illustrated in any of in any of FIGS. 1-25.

The network entity 604 may generally be capable of communicating with the UE 602 using one or more transmit beams, and the UE 602 may further be capable of communicating with the network entity 604 using one or more receive beams. As used herein, the term transmit beam refers to a beam on the network entity 604 that may be utilized for downlink or uplink communication with the UE 602. In addition, the term receive beam refers to a beam on the UE 602 that may be utilized for downlink or uplink communication with the network entity 604.

In the example shown in FIG. 6, the network entity 604 is configured to generate a plurality of transmit beams 606a-606h, each associated with a different spatial direction. In addition, the UE 602 is configured to generate a plurality of receive beams 608a-608e, each associated with a different spatial direction. It should be noted that while some beams are illustrated as adjacent to one another, such an arrangement may be different in different aspects. For example, transmit beams 606a-606h transmitted during the same symbol might not be adjacent to one another. In some examples, the network entity 604 and the UE 602 may each transmit more or fewer beams distributed in all directions (e.g., 360 degrees) and in three-dimensions. In addition, the transmit beams 606a-606h may include beams of varying beam width. For example, the network entity 604 may transmit certain signals (e.g., SSBs) on wider beams and other signals (e.g., CSI-RSs) on narrower beams.

The network entity 604 and the UE 602 may select one or more transmit beams 606a-606h on the network entity 604 and one or more receive beams 608a-608e on the UE 602 for communication of uplink and downlink signals therebetween using a beam management procedure. In one example, during initial cell acquisition, the UE 602 may perform a P1 beam management procedure to scan the plurality of transmit beams 606a-606h on the plurality of receive beams 608a-608e to select a beam pair link (e.g., one of the transmit beams 606a-606h and one of the receive beams 608a-608e) for a physical random access channel (PRACH) procedure for initial access to the cell. For example, periodic SSB beam sweeping may be implemented on the network entity 604 at certain intervals (e.g., based on the SSB periodicity). Thus, the network entity 604 may be configured to sweep or transmit an SSB on each of a plurality of wider transmit beams 606a-606h. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the network entity 604 and the UE 602 may perform a P2 beam management procedure for beam refinement. For example, the network entity 604 may be configured to sweep or transmit a CSI-RS on each of a plurality of narrower transmit beams 606a-606h. Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by a gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 602 is configured to scan the plurality of CSI-RS transmit beams 606a-606h on the plurality of receive beams 608a-608e. The UE 602 then performs beam measurements (e.g., RSRP, SINR, etc.) of the received CSI-RSs on each of the receive beams 608a-608e to determine the respective beam quality of each of the CSI-RS transmit beams 606a-606h as measured on each of the receive beams 608a-608e.

The UE 602 can then generate and transmit a Layer 1 (L1) measurement report, including the respective beam index (e.g., CSI-RS resource indicator (CRI)) and beam measurement (e.g., RSRP) of one or more of the CSI-RS transmit beams 606a-606h on one or more of the receive beams 608a-608e to the network entity 604. The network entity 604 may then select one or more CSI-RS transmit beams on which to transmit unicast downlink control information and/or user data traffic to the UE 602. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 602 may further select a corresponding receive beam on the UE 602 for each selected serving CSI-RS transmit beam to form a respective downlink beam pair link (BPL) for each selected serving CSI-RS transmit beam. For example, the UE 602 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, the network entity 604 may configure the UE 602 to perform SSB beam measurements and provide an L1 measurement report containing beam measurements of SSB transmit beams 606a-606h. For example, the network entity 604 may configure the UE 602 to perform SSB beam measurements and/or CSI-RS beam measurements for beam failure detection (BRD), beam failure recovery (BFR), cell reselection, beam tracking (e.g., for a mobile UE 602 and/or network entity 604), or some other beam optimization purpose.

In addition, when the channel is reciprocal, the transmit and receive beams may be selected using an uplink beam management scheme. In an example, the UE 602 may be configured to sweep or transmit on each of a plurality of receive beams 608a-608e. For example, the UE 602 may transmit an SRS on each beam in the different beam directions. In addition, the network entity 604 may be configured to receive the uplink beam reference signals on a plurality of transmit beams 606a-606h. The network entity 604 then performs beam measurements (e.g., RSRP, SINR, etc.) of the beam reference signals on each of the transmit beams 606a-606h to determine the respective beam quality of each of the receive beams 608a-608e as measured on each of the transmit beams 606a-606h.

The network entity 604 may then select one or more transmit beams on which to transmit unicast downlink control information and/or user data traffic to the UE 602. In some examples, the selected transmit beam(s) has (have) the highest RSRP. The UE 602 may then select a corresponding receive beam for each selected serving transmit beam to form a respective beam pair link (BPL) for each selected serving transmit beam, using, for example, a P3 beam management procedure, as described above.

In one example, a single transmit beam (e.g., the transmit beam 606d) on the network entity 604 and a single receive beam (e.g., the receive beam 608c) on the UE 602 may form a single BPL used for communication between the network entity 604 and the UE 602. In another example, multiple transmit beams (e.g., transmit beams 606c, 606d, and 606e) on the network entity 604 and a single receive beam (e.g., receive beam 608c) on the UE 602 may form respective BPLs used for communication between the network entity 604 and the UE 602. In another example, multiple transmit beams (e.g., transmit beams 606c, 606d, and 606e) on the network entity 604 and multiple receive beams (e.g., receive beams 608c and 608d) on the UE 602 may form multiple BPLs used for communication between the network entity 604 and the UE 602. In this example, a first BPL may include the transmit beam 606c and the receive beam 608c, a second BPL may include the transmit beam 608d and the receive beam 608c, and a third BPL may include the transmit beam 608e and the receive beam 608d.

In some examples, to select one or more downlink transmit beams and one or more downlink receive beams for communication with a UE 602, the network entity 604 may transmit a reference signal, such as an SSB or CSI-RS, on each of a plurality of downlink transmit beams in a beam-sweeping manner. The UE 602 may measure the reference signal received power (RSRP) on each of the downlink transmit beams using one or more downlink receive beams on the UE 602 and transmit a beam measurement report to the network entity 604 indicating the RSRP of each of the measured downlink transmit beams. The network entity 604 may then select one or more serving downlink beams (e.g., downlink transmit beams and downlink receive beams) for communication with the UE 602 based on the beam measurement report. The resulting selected downlink transmit beam and downlink receive beam may form a downlink beam pair link. In other examples, when the channel is reciprocal, the network entity 604 may derive the particular downlink beam(s) to communicate with the UE 602 based on uplink measurements of one or more uplink reference signals, such as sounding reference signals (SRSs).

In some examples, uplink beams (e.g., uplink transmit beam(s) at the UE 602 and uplink receive beam(s) at the network entity 604) may be selected by measuring the RSRP of received uplink reference signals (e.g., SRSs) or downlink reference signals (e.g., SSBs or CSI-RSs) during an uplink or downlink beam sweep. For example, the network entity 604 may determine the uplink beams either by uplink beam management via an SRS beam sweep with measurement at the network entity 604 or by downlink beam management via an SSB/CSI-RS beam sweep with measurement at the UE 602. The selected uplink beam may be indicated by a selected SRS resource (e.g., time-frequency resources utilized for the transmission of an SRS) when implementing uplink beam management or a selected SSB/CSI-RS resource when implementing downlink beam management. For example, the selected SSB/CSI-RS resource can have a spatial relation to the selected uplink transmit beam (e.g., the uplink transmit beam utilized for the PUCCH, SRS, and/or PUSCH). The resulting selected uplink transmit beam and uplink receive beam may form an uplink beam pair link.

As mentioned above, mobility procedures may include, for example, procedures relating to a beam switch, handover to a cell, and so on. In some examples, a UE may encounter two types of mobility: cell-level mobility and beam-level mobility (which may be beam-based mobility). For cell-level mobility, a UE may experience an inter-base station handover. In some wireless communication systems, for beam-level mobility, switching of beams may occur within the same base station.

Beams may be switched in response to various conditions. For example, a transmission configuration indication (TCI) state change may be transmitted by a base station to instruct a UE to switch to a new beam. The TCI state change may cause the UE to find the best UE receive beam corresponding to the TCI state from the base station, and switch to this beam. Switching beams may allow for enhanced or improved connection between the UE and the base station by ensuring that the transmitter and receiver use the same configured set of beams for communication. As used herein, the term “beam” may refer to a spatial filter associated with a transmission.

A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL reference signals (RSs) in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for channel quality information (CQI) management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

As another example, a spatial relation change, such as a spatial relation update, may trigger the UE to switch beams. Beamforming may be applied to uplink channels, such as but not limited to PUCCH. Beamforming may be based on configuring one or more spatial relations between the uplink and downlink signals. Spatial relation may indicate that a UE may transmit the uplink signal using the same beam as it used for receiving the corresponding downlink signal.

Different procedures for managing and controlling beam may be collectively referred to as “beam management.” The process of selecting a beam to switch to for data channels or control channels may be referred to as “beam selection.” In some wireless communication systems, beam selection for data channels or control channels may be performed for beams within the same physical cell identifier (ID) (PCI).

As mentioned above, in some scenarios, a wireless communication network may coexist with (e.g., use the same wireless communication resources as) another wireless communication network. One example of such coexistence is between a satellite network and a terrestrial network (e.g., a ground-based 5G or 6G network). For example, FR3 frequencies may overlap with a frequency band used by a satellite.

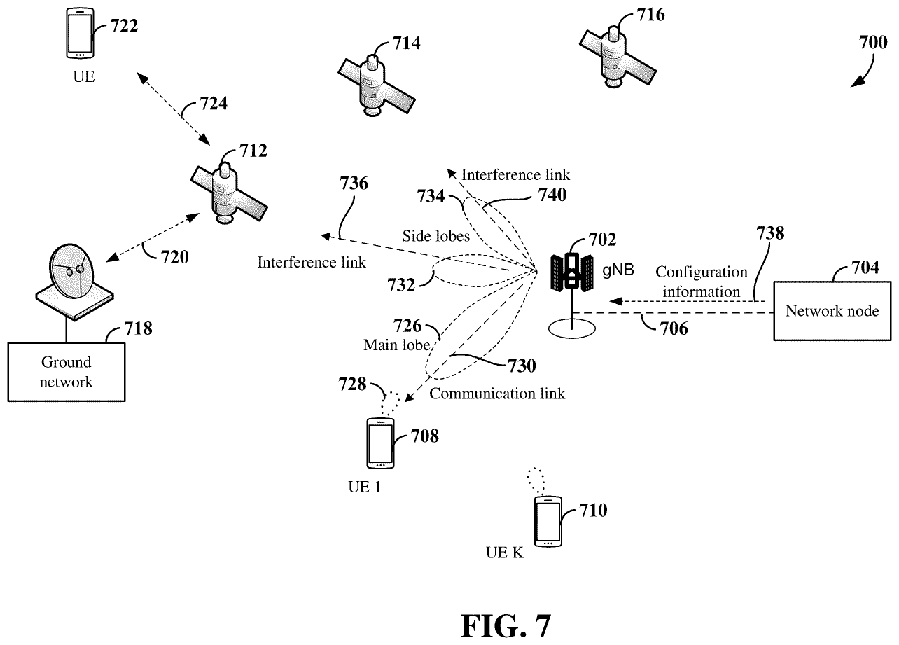

FIG. 7 depicts a diagram 700 that illustrates an example of coexistence issues that may occur between a satellite network and a 5G or 6G network according to some aspects. In the diagram 700, a network entity 702 (e.g., a gNB) is connected to a network node 704 via a wired or wireless link 706 and communicates with various UEs (e.g., a UE 708 and a UE 710) via wireless beamformed links. The network node 704 is connected to at least one other network (not shown) to provide network service to the UEs via the network entity 702.

In some examples, the UEs (e.g., the UE 708 and the UE 710) may correspond to any of the UEs, CPEs, relay devices, or scheduled entities shown in any of FIGS. 1, 2, 3, 5, 6, 8, 9, 12, 13, 14, 15, and 16. In some examples, the network entity 702 may correspond to any of the network entities, base stations, CUs, DUs, RUs, or scheduling entities shown in any of FIGS. 1, 2, 3, 5, 6, 8, 9, 12, 13, 14, 15, and 19. In some examples, the network node 704 may correspond to any of the core network entities, external data network entities, and so on, shown in any of FIGS. 1, 3, 8, 9, 12, 13, 14, and 15.

Also shown in the diagram 700 are several satellites (e.g., a satellite 712, a satellite 714, and a satellite 716) that are connected to a ground network 718 via satellite links (e.g., e.g., feeder links 720) and communicate with various UEs (e.g., a UE 722) via satellite links (e.g., service links 724). The ground network 718 is connected to at least one other network (not shown) to provide network service to the UEs via the satellites. In some examples, the satellites of FIG. 7 are low earth orbit (Leo) satellites.

In the example of FIG. 7, the network entity 702 is communicating with the UE 708 via a main lobe 726 (beamformed lobe) and the UE 708 is configured with a complementary antenna element radiation pattern 728 (e.g., as described above in the discussion of beam pair selection). Thus, the network entity 702 may transmit information to the UE 708 via a corresponding communication link 730.

The generation of the main lobe 726 by the network entity 702 also results in the generation of side lobes (e.g., a side lobe 732 and a side lobe 734). In this case, in the event a satellite is relatively close to the network entity 702 (e.g., noting that satellites generally employ very sensitive receivers to acquire transmissions from ground-based UEs), transmissions by the network entity 702 may interfere with receive operations at a satellite. For example, signal energy generated by the side lobe 732 may result in an interference link 736 that adversely affects receive operations at the satellite 712. Similarly, signal energy generated by the side lobe 734 may result in an interference link 740 that adversely affects receive operations at the satellite 714.

Also, in a TDD terrestrial-UL scenario, the transmissions from active UEs, CPEs, and other devices can cause interference at one or more satellites. In some aspects, the amount of this interference may depend on power-spectral densities, array orientations, and other transmission characteristics used by the UEs.

The disclosure relates in some aspects to the use of configuration information and/or other information 738 to mitigate the above coexistence issues. For example, as discussed below, a network node may send the information 738 to the network entity 702 to enable the network entity 702 to reduce the amount of interference imposed on a satellite or other device (e.g., by reducing transmitted signal energy in general, or in a certain direction or directions).

The disclosure relates in some aspects to the use of coexistence constraints for terrestrial down-link (DL) transmissions to protect the satellite uplink (UL) from interference due to transmissions by network entities (e.g., interference caused by side lobes) or other terrestrial devices. In some examples, the coexistence target is to maintain less than a threshold (e.g., 1 dB) impact of interference on each satellite's UL, compared to a baseline (e.g., no sharing of spectrum with terrestrial users).

In general, it may be more likely for a terrestrial device to interfere with a Leo satellite when the satellite is at lower elevation angles (e.g., where side lobes of the terrestrial device may be more prominent). In any event, the impact of the terrestrial device's interference on a Leo satellite is typically more severe in this case. Thus, a target interference upper-bound on a satellite UL might be exceeded in the absence of interference mitigation.

Through the use of coexistence related constraints as taught herein, a target satellite interference limit can be met, while degrading the terrestrial UE signal-to-noise ratio (SNR) only slightly, by controlling the beamforming in an appropriate manner (e.g., 0.1 dB SNR degradation in an example study done for upper midband FR3 spectrum in a real-world setting). In some examples, coexistence aware beamforming by a network entity may involve the use of side-information provided to the network entity. This side information may be used by the network entity or some other device to reconfigure a beamforming mode and/or antenna element radiation patterns. For example, the side information may precipitate a switch to the use of digital beamforming to reduce side lobe caused interference.

In some aspects, different beamforming modes (e.g., a digital-dominant mode or an analog-dominant mode) offer different tradeoffs between performance and power consumption. Transmissions using analog-dominant modes (e.g., using analog phase shifters) can result in larger side-lobes for beamforming/precoding under coexistence constraints (especially if these modes imply the use of fewer antennas and/or the use of coarse phase-shifters). In contrast, even in a rank-1 (single-layer) scenario, using a digital dominant mode can provide noticeably better performance than an analog-dominant mode for beamforming under multiple coexistence constraints. This is because a digital dominant mode may use more flexible unequal magnitude beamforming and/or use more antennas. However, there may be increased cost in terms of power consumption in this case.

Similarly, changing antenna element radiation patterns may provide additional beamforming control (e.g., which traditional beamforming via antenna element phase adaptation might not provide). Thus, a change in an antenna radiation pattern (e.g., for an antenna, an antenna panel, or an antenna element) can be significantly beneficial for coexistence.

In general, coexistence related constraints as taught herein may be employed in any coexistence scenario involving an incumbent system. For example, coexistence issues may arise in a scenario where a satellite, a CPE, a relay device, or some other device is subject to interference from another device.

Thus, the disclosure relates in some aspects to providing information (e.g., side-information) to a network entity, CPE, or some other device that will enable the device to adjust its communication attributes to achieve efficient coexistence with an incumbent system. In some examples, these communication attributes may include one or more of a choice of modes, beamforming codebooks, transmit powers, bandwidth parts, array-tilts, element radiation patterns, or other scheduled resources (e.g., scheduled for UEs, etc.).

In some examples, requirements for coexistence with an incumbent system (e.g., a maximum interference level) may be mapped to time-varying constraints (e.g., which can be known in advance). These requirements may be conveyed to a network entity, a CPE, or other device via look-up tables (e.g., which can be updated according to a configured time-schedule or in some other manner). A network entity, CPE, etc., can retrieve from the look-up table a set of parameters for each time-interval indicated by the table and infer from those parameters, communications settings and/or attributes to be used such as: beamforming modes, beamformers, antenna arrays, element radiation pattern tilts, transmit powers, bandwidth parts, and so on.

In some examples, the requirements for coexistence can be translated to restrictions on communication settings for each time-interval by a network node. In this case, the network node can covey these restricted settings (e.g., restrictions on one or more of beam, mode, array-tilt/element-radiation-pattern, bandwidth, power, and so on) to a network entity, a CPE, etc.

In some examples, a network node may use ephemeris data to configure a look-up table (or other suitable data set) for a network entity, etc. For example, each day of the year may be partitioned into basic time-intervals (e.g., corresponding to different locations of one or more satellites). Examples of such time-intervals may be 1 second, 100 milliseconds, or some other period of time.

In some examples, the table may contain one or more fields for each basic time-interval. In some examples, one field in the table may specify angular coordinates/directions for each one of a set of N (Nsat) dominantly interfered Leo satellites, the orientation of the main lobe the satellite uses for receiving, and/or other position information. The set of Nsat satellites may vary across time-intervals and can be network entity specific.

In some examples, the table may include a default Mask field. This field can be used to set a maximum interference level, which the leakage signal of a network entity and/or other devices (e.g., the UEs served by the network entity) is to satisfy for each of the dominant Nsat satellites for an indicated bandwidth part (BWP). The interference level and BWP can be satellite specific. These parameters may vary across time-intervals in some examples.

Table 1 illustrates an example of a table that includes such time-varying constraints (e.g., to be used by a particular network entity). Similar information may be provided for each satellite. Other types of tables and/or tables including other types of information may be used in other examples.

TABLE 1

| | | | Characteristic |
|---|---|---|---|
| | | | (e.g., maximum |
| Time | Satellite | BWP | interference or |
| period | Information | Information | allowed leakage) |
| 1 | 1^{st} coordinates or | BWP-ID | X dB |
| | direction for sat #1 | | |
| 2 | 2^{nd} coordinates or | BWP-ID | X dB |
| | direction for sat #1 | | |
| 3 | 3^{rd} coordinates or | BWP-ID | Y dB |
| | direction for sat #1 | | |
| . . . | . . . | . . . | . . . |
| N | Nth coordinates or | BWP-ID | Z dB |
| | direction for sat #1 | | |

In some examples, the table may be reconfigured or updated (e.g., on a non-periodic repeated basis or every designated time-interval). For example, a table may be specified for one month, one fortnight, one day a time, and so on. This can allow for more accurate forecasting of atmospheric events (which impact propagation channels between the network entity, etc., and the satellites) and expected satellite traffic.

The disclosure relates in some aspects to the use of a mask override (e.g., to temporarily override (supersede) constraints previously received by a network entity, etc.). In some examples, the mask override may be an event-triggered mask override indication. In some examples, this override may account for unexpected events such as a solar flare event, atypical atmospheric drag, rain/precipitation, satellite failures, and so on.

As one example of a mask override, a network node may specify a new updated maximum interference level that a leakage signal of network entity, etc., is expected to satisfy for each of the dominant satellites for an indicated BWP. The network node may then send an indication of the override to the corresponding network entity, etc., which will adjust its settings or take other action (e.g., send a message to another device) so that the appropriate transmission parameters, etc., may be configured at transmitting device.

Also, the network node may specify a validity timer (e.g., a duration of time) after the expiry of which the network entity, etc., can revert to the most recent default mask settings. This timer information may be sent with the mask override (e.g., via a backhaul message or some other type of message) or in a separate message (e.g., a group timer may be used in some cases).

A network entity may take various actions (e.g., to limit leakage in a particular direction) based on a received table. Several examples are described below.

In some examples, a network entity may switch to a digital mode from an analog mode or vice versa, in its (terrestrial) UL and/or DL, based on configured mask constraints. For example, the use of a digital mode may improve compliance with the mask constraints while maintaining beamforming gain and communications-link quality. In the DL, a digital mode can reduce side-lobes, introduce transmission nulls towards specified satellites, and direct energy better towards intended user (potentially at the cost of higher energy usage). As noted above, the use of analog mode may result in lower energy consumption, but with higher leakage.

Similarly, in the UL, the use of a digital mode may enable a network entity to receive energy more effectively from an intended user (potentially at the cost of higher network entity energy usage). Again, the use of an analog mode may consume less network entity energy, but may capture less desired signal energy. Thus, the transmit power required by UE to maintain link-quality may be directly impacted.

In some examples, a network entity may optimize its scheduling, given that mask constraints are known in advance from the configured table. These actions include, for example: adjusting codebooks (e.g., switch to (or generate) a codebook that provides a different side lobe profile); choice of beamformers and/or precoders (e.g., to adjust a main lobe gain in a particular direction and/or adjust a side lobe gain in a particular direction); adjusting DL transmit power; adjusting used or assigned DL frequency resources or bandwidth parts; adjusting one or more UEs' receive modes to digital from analog or vice versa; enabling or disabling its antenna panels; optimizing antenna tilt further using mechanical (if available) or electronic options; or optimizing antenna element radiation patterns (if the network entity has reconfigurable antennas).

The disclosure relates in some aspects to a network entity directing devices (e.g., served UEs, CPEs, etc.) to mitigate interference caused by transmissions by those devices to the satellite UL (e.g., transmissions by a group of UEs served by a network entity may collectively result in non-negligible interference at a satellite). In some aspects, this may be achieved while maintaining efficiency in resource utilization. For example, based on a configured mask and/or estimates of a UE's antenna panel orientations (e.g., which may be indicated by each UE) and their locations, the network entity may instruct one or more UEs to change one or more parameters and/or operating conditions. For example, the network entity may instruct a UE to change its beamforming mode to digital from analog or vice-versa, adjust its transmit power, adjust its assigned frequency resources, reconfigure antenna element radiation patterns (e.g., if the UE has reconfigurable antennas), or disable one or more of its antenna modules (e.g., in conjunction with recommendations to switch to landscape or portrait display mode).

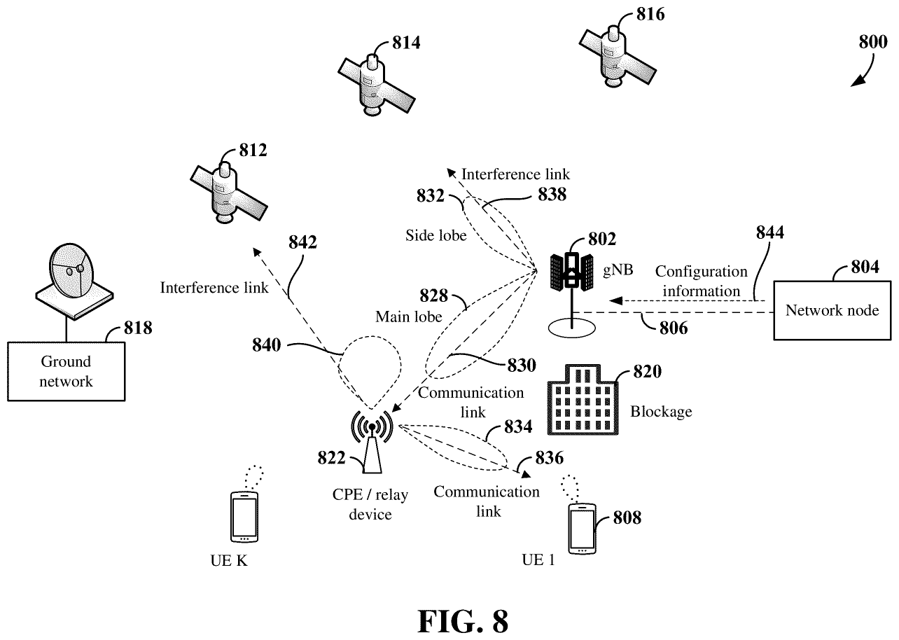

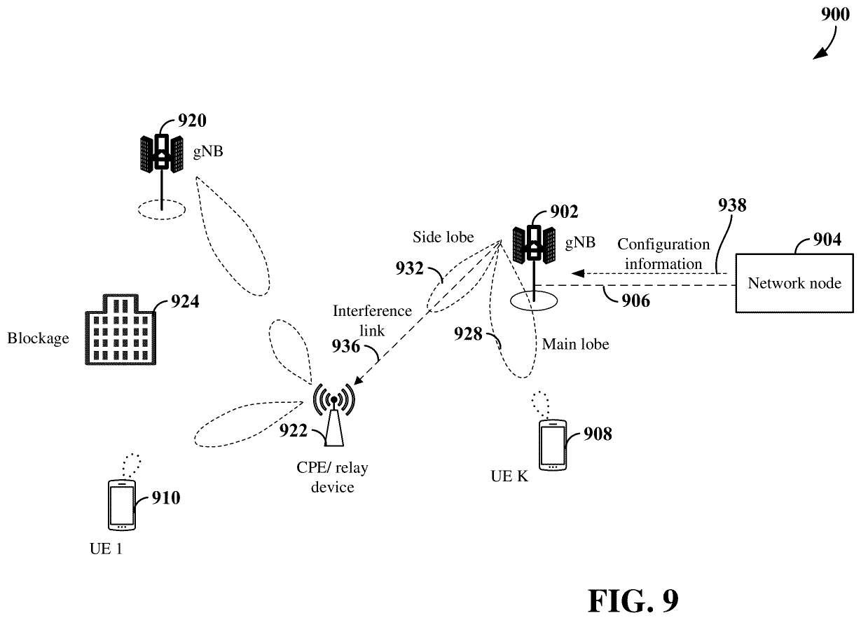

As mentioned above, the disclosure relates to interference scenarios other than the network entity and satellite interference scenario discussed above. FIGS. 8 and 9 illustrate two examples of such scenarios.

FIG. 8 is directed to a scenario involving a terrestrial down-link (DL) with coexistence constraints dictated by a satellite UL. Here, provisions may be made to protect the satellite uplink (UL) from interference due to network entity and CPE transmissions caused by respective sidelobes/leakage.

In the diagram 800 of FIG. 8, a network entity 802 (e.g., a gNB) is connected to a network node 804 via a wired or wireless link 806 and communicates with various UEs (e.g., a UE 808) via wireless beamformed links. The network node 804 is connected to at least one other network (not shown) to provide network service to the UEs via the network entity 802.

In some examples, the UEs (e.g., the UE 808) may correspond to any of the UEs, CPEs, relay devices, or scheduled entities shown in any of FIGS. 1, 2, 3, 5, 6, 7, 9, 12, 13, 14, 15, and 16. In some examples, the network entity 802 may correspond to any of the network entities, base stations, CUs, DUs, RUs, or scheduling entities shown in any of FIGS. 1, 2, 3, 5, 6, 7, 9, 12, 13, 14, 15, and 19. In some examples, the network node 804 may correspond to any of the core network entities, external data network entities, and so on, shown in any of FIGS. 1, 3, 7, 9, 12, 13, 14, and 15.

Also shown in the diagram 800 are several satellites (e.g., a satellite 812, a satellite 814, and a satellite 816) that are connected to a ground network 818 via satellite links and communicate with various UEs (not shown) via satellite links as discussed above. The ground network 818 is connected to at least one other network (not shown) to provide network service to the UEs via the satellites. In some examples, the satellites are Leo satellites.

In the example of FIG. 8, due to a blockage 820 (e.g., due to a building or some other blocking structure), the network entity 802 is not able to communicate with the UE 808. However, the network entity 802 does communicate with a CPE 822 or other similar device that can communicate with the UE 808.

In this case, the network entity 802 communicates with the CPE 822 via a main lobe 828 (beamformed lobe). Thus, the network entity 802 may transmit information to the CPE 822 via a corresponding communication link 830.

In addition, the CPE 822 communicates with the UE 808 via a main lobe 834 (beamformed lobe). Thus, the CPE 822 may transmit information to the UE 808 via a corresponding communication link 836.

The generation of the main lobe 828 by the network entity 802 also results in the generation of side lobes (e.g., a side lobe 832). In this case, in the event a satellite is relatively close to the network entity 802 as discussed above, transmissions by the network entity 802 may interfere with receive operations at a satellite. For example, signal energy generated by the side lobe 832 may result in an interference link 838 that adversely affects receive operations at the satellite 814.

Similarly, the generation of the main lobe 834 by the CPE 822 also results in the generation of side lobes (e.g., a side lobe 840). In this case, in the event a satellite is relatively close to the CPE 822 (e.g., as discussed above for a network entity), transmissions by the CPE 822 may interfere with receive operations at a satellite. For example, signal energy generated by the side lobe 840 may result in an interference link 842 that adversely affects receive operations at the satellite 812.

In a similar manner as discussed above, the network node 804 may send information 844 to the network entity 802 to enable the network entity 802 to reduce the amount of interference it imposes on a satellite or other device. Alternative or in addition, the network entity may send information (e.g., based on the information 844) to the CPE 822 to enable the CPE 822 to reduce the amount of interference it imposes on a satellite or other device.

FIG. 9 is directed to a scenario involving a terrestrial network with coexistence constraints. Here, provisions may be made to protect one or more CPEs/relaying/forwarding-devices or DUs from interference due to transmissions by another other network entity/TRP/DU (e.g., interference caused by sidelobe leakage). In some cases, a CPE might need protection only during certain times of day when it is serving its UEs. Thus, these times may be known or can be predicted in advance (e.g., specific time-windows in residential and/or enterprise applications).

In the diagram 900 of FIG. 9, a network entity 902 (e.g., a gNB) is connected to a network node 904 via a wired or wireless link 906 and communicates with various UEs (e.g., a UE 908) via wireless beamformed links. The network node 904 is connected to at least one other network (not shown) to provide network service to the UEs via the network entity 902. In addition, a network entity 920 communicates with a CPE 922 (e.g., to avoid a blockage 924). The CPE 922, in turn, communicates with one or more UEs (e.g., a UE 910).

In some examples, the UEs (e.g., the UE 908 or 910) may correspond to any of the UEs, CPEs, relay devices, or scheduled entities shown in any of FIGS. 1, 2, 3, 5, 6, 7, 8, 12, 13, 14, 15, and 16. In some examples, the network entity 902 or the network entity 920 may correspond to any of the network entities, base stations, CUs, DUs, RUs, or scheduling entities shown in any of FIGS. 1, 2, 3, 5, 6, 7, 8, 12, 13, 14, 15, and 19. In some examples, the network node 904 may correspond to any of the core network entities, external data network entities, and so on, shown in any of FIGS. 1, 3, 7, 8, 12, 13, 14, and 15.

The network entity 902 communicates with the UE 908 via a main lobe 928 (beamformed lobe). The generation of the main lobe 928 by the network entity 902 also results in the generation of side lobes (e.g., a side lobe 932). In this case, in the event the CPE 922 is relatively close to the network entity 902, transmissions by the network entity 902 may interfere with receive operations at the CPE 922. For example, signal energy generated by the side lobe 932 may result in an interference link 936 that adversely affects receive operations at the CPE 922.

In a similar manner as discussed above, the network node 904 may send information 938 to the network entity 902 to enable the network entity 902 to reduce the amount of interference it imposes on the CPE 922 or other devices.

In some examples, a network node can directly configure a table for a CPE in a similar manner as described previously for the network entity. In this case, the CPE may autonomously operate, adhering to coexistence limits.

In some examples, a network node can provide a finer description of the CPE backhaul and/or access beams (for both the CPE's analog and digital modes in the case of a dual mode CPE) to a network entity. The network entity can also provide an additional table describing, for example, prominent side lobe directions and gains along these direction, orientations of dominant set of satellites from the perspective of the CPE, and the respective leakage constraints of the satellite. The network entity can then direct a dual-mode CPE to switch to digital mode from analog mode or vice versa, in its backhaul or access links based on configured mask constraints.

In some examples, a network entity can further optimize its scheduling given that mask constraints are known in advance from the configured tables. For example, the network entity may perform one or more of: adjust CPE codebooks, adjust its choice of beamformers/precoders, adjust the CPE's access-link transmit power, adjust used or assigned CPE frequency resources or bandwidth parts, adjust the receive or transmit modes of one or more UEs to digital from analog or vice versa, enable CPE antenna panels, disable CPE antenna panels, optimize CPE array tilt further using mechanical (if available) or electronic options, and so on.

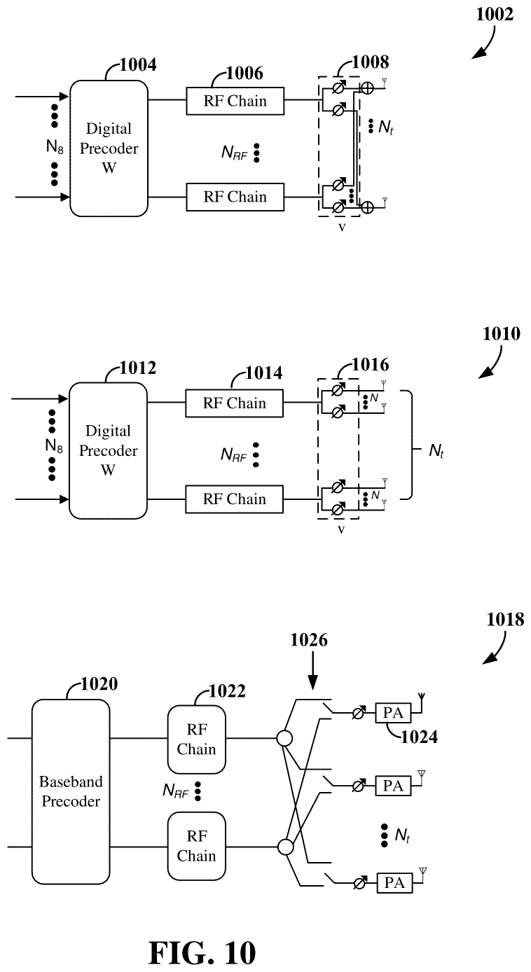

FIG. 10 illustrates examples of circuitry that may be configured to achieve different mode architecture options (e.g., as discussed above). For example, these architectures may be used for dynamically activating and deactivating RF chains and/or dynamically connecting different antennas (e.g., antenna elements) to different RF chains.

A first diagram 1002 illustrates an example of RF chain circuitry than may be activated or deactivated (e.g., under the control of a processing system). Here a digital precoder 1004 provides a set of signals to a set of RF chains (e.g., including an RF chain 1006). In this fully connected scheme, each RF chain is connected to each antenna element via power amplifier (PA) circuits 1008. The input of each PA of each antenna element is the phase-weighted sum of all RF chain outputs.

A second diagram 1010 illustrates an example of antenna module/group and associated RF chain circuitry than may be activated or deactivated (e.g., under the control of a processing system). Here a digital precoder 1012 provides a set of signals to a set of RF chains (e.g., including an RF chain 1014). In this sub-connected scheme, the input of the PA (PA circuits 1016) of each antenna element is the phase-weighted output of a specific RF-chain.

A third diagram 1018 illustrates an example of antenna module/group and RF chain circuitry than may be activated or deactivated (e.g., under the control of a processing system). Here a baseband precoder 1020 provides a set of signals to a set of RF chains (e.g., including an RF chain 1022). In this sub-connected scheme, the input of the PA (e.g., PA 1024) of each antenna element is the phase-weighted output of any selected RF-chain (e.g., as controlled by switch array 1026).

In some examples, a grouped sub-connected architecture may be employed where RF chains are divided into multiple (G) groups and a set of antenna elements are also partitioned to G groups. Each group of RF chains is assigned a distinct group of antennas. Within a group the architecture is fully-connected.

In the examples set forth above, each antenna element may be reconfigurable (e.g., through the use of a radiation pattern re-configurable antenna element). For example, each antenna element may be coupled to a parasitic layer and by changing the state of that layer (e.g., via a biasing circuit) the radiation pattern of the antenna element may be altered.

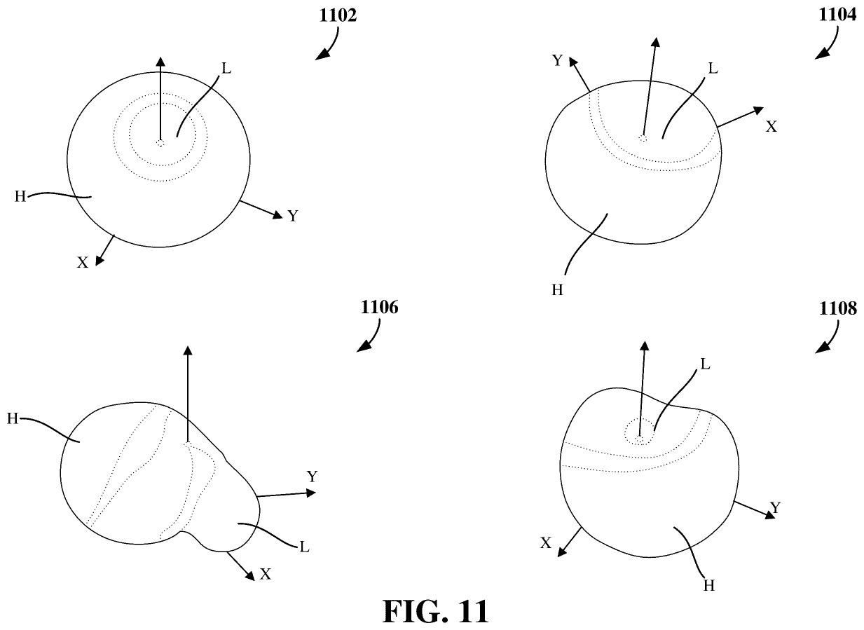

FIG. 11 illustrates an example of a re-configurable antenna element 4-state radiation pattern (e.g., at FR1/FR3). In some aspects, the use of re-configurable antenna elements enables coexistence to be done at a finer level. In FIG. 11, four different potential radiation patterns are shown in a simplified form in diagram 1102 (mode 1), diagram 1104 (mode 2), diagram 1106 (mode 3), and diagram 1108 (mode 4). Each pattern includes areas of relatively higher energy H and areas of relatively lower energy L.

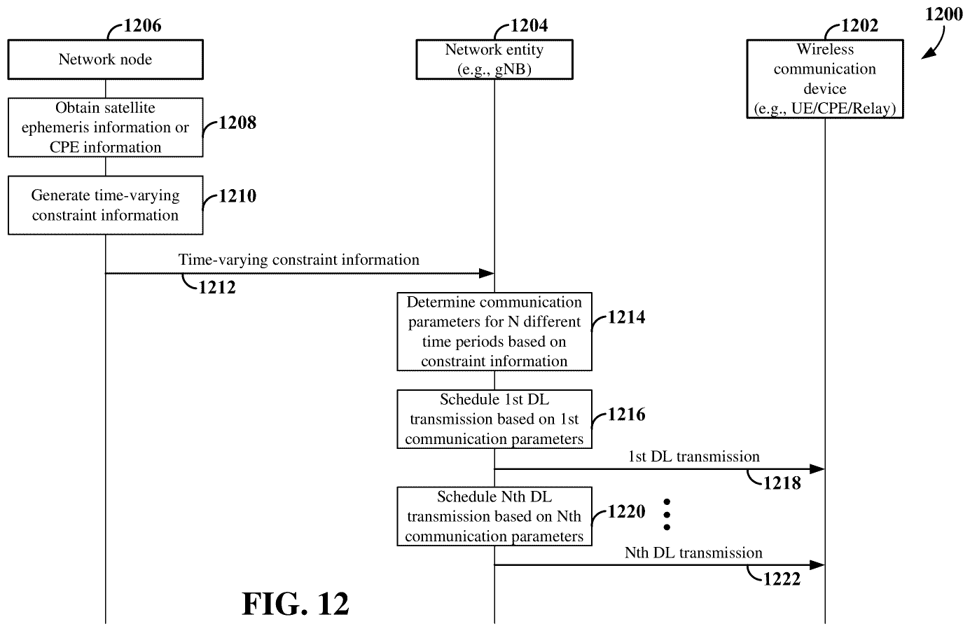

FIG. 12 is a signaling diagram 1200 illustrating an example of coexistence related signaling in a wireless communication system including a wireless communication device 1202, a network entity 1204, and network node 1206 (e.g., a core network node). In some examples, the wireless communication device 1202 may correspond to any of the UEs, CPEs, relay devices, or scheduled entities shown in any of FIGS. 1, 2, 3, 5, 6, 7, 8, 9, 13, 14, 15, and 16. In some examples, the network entity 1204 may correspond to any of the network entities, base stations, CUs, DUs, RUs, or scheduling entities shown in any of FIGS. 1, 2, 3, 5, 6, 7, 8, 9, 13, 14, 15, and 19. In some examples, the network node 1206 may correspond to any of the core network entities, external data network entities, and so on, shown in any of FIGS. 1, 3, 7, 8, 9, 13, 14, and 15.

At #1208 of FIG. 12, the network node 1206 may obtain satellite ephemeris information, CPE information, or other information that indicates one or more time-varying communication aspects of one or more satellites, one or more CPEs, or some other wireless communication entity or entities.

As one example, a ground network for a satellite system may maintain (e.g., update, as needed) ephemeris data associated with the satellites of the satellite system and the network node 1206 may obtain this information from the ground network or some other entity that has access to this information. This ephemeris data may indicate for each satellite, for example, one or more of the location of the satellite a various points in time, frequency bands used by the satellite (e.g., at various points in time), the orientation of the satellite's antenna(s) at various points in time, and so on. In some examples, the frequency bands used by a satellite may be fixed (e.g., this information may be known and, therefore, not included in ephemeris data).

As another example, a network entity that serves a CPE may maintain (e.g., regularly update, as needed) information regarding periods of time the CPE is operating, frequency bands used by the CPE (e.g., at various points in time), the orientation of the CPE's antenna(s) at various points in time, and so on. In this case, the network node 1206 may obtain this information from the serving network entity or some other entity that has access to this information.

At #1210, the network node 1206 may generate time-varying constraint information associated with a satellite, a CPE, etc., based on the information obtained at #1208. For example, the network node 1206 may determine, based on the position information for a given satellite, angular coordinates/directions for that satellite relative to the network entity 1204 for different periods of time. As another example, the network node 1206 may determine, based on position, frequency, and antenna orientation information for a given satellite, maximum interference levels to be satisfied by the network entity 1204 (e.g., for a particular BWP) for different periods of time.

At #1212, the network node 1206 sends the time-varying constraint information to the network entity 1204. For example, the network node 1206 may send this information as a look-up table, as a data set, or in some other form.

At #1214, the network entity 1204 determines time-varying communication parameters (e.g., settings, attributes, etc.) to be used for different time periods based on the time-varying constraint information received at #1212. For example, the network entity 1204 may determine a first set of communication parameters to be used during a first time period, a second set of communication parameters to be used during a second time period, and so on.

As discussed above, these communication parameters may include, for example, one of more of a beamforming mode, a beamformer, a beamforming codebook, an antenna configuration, antenna element tilt information, an antenna radiation pattern, a transmit power, a bandwidth, and so on. For example, the network entity 1204 may elect to switch from an analog beamforming mode to a digital beamforming mode during a certain period of time to ensure that potential side lobe interference estimated for a particular satellite, CPE, etc., (e.g., a satellite at a particular direction, using a particular frequency band, and having a particular antenna orientation) is below a maximum interference level specified for that satellite, CPE, etc., during that time period on a particular frequency band (e.g., corresponding to a particular BWP). As another example, the network entity 1204 may switch to the use of a different beamforming codebook during that time period to reduce potential interference at the satellite, CPE, etc. As a further example, the network entity 1204 may change one or more antenna settings (e.g., activate or deactivate a particular antenna, antenna panel, or antenna element; change the tilt of a particular antenna, antenna panel, or antenna element; and so on) to reduce potential interference at the satellite, CPE, etc. As yet another example, the network entity 1204 may reduce its transmit power or use a different frequency band during the time period to reduce potential interference at the satellite, CPE, etc. Other communication parameters may be adjusted in other examples to achieve a similar result.

At #1216, the network entity 1204 schedules a first downlink transmission (e.g., that is to occur during a first time period) to the wireless communication device 1202 based on a first set of the communication parameters (corresponding to the first time period) determined at #1214. For example, the network entity 1204 may indicate (e.g., in a DCI) beam information (e.g., antenna ports, TCI state, etc.), frequency information (e.g., a frequency domain resource assignment (FDRA), BWP indicator, etc.), and so on for the first downlink transmission based on the first set of the communication parameters.

At #1218, the network entity 1204 transmits the first downlink transmission based on the first set of the communication parameters. For example, as discussed above, the network entity 1204 may use, for the first transmission, one or more of a particular beamforming mode, a particular beamforming codebook, particular antenna settings, a particular transmit power, etc., determined at #1214 for the first time period. Thus, interference at particular satellite, CPE, or other wireless communication device may be mitigated, facilitating coexistence with such a device.

The network entity 1204 may then continue to use the communication parameters determined at #1214 for subsequent transmissions during the first time period and during any other time periods covered by these communication parameters. For example, for an Nth time period, at #1220, the network entity 1204 schedules an Nth downlink transmission to the wireless communication device 1202 based on an Nth set of the communication parameters. Then, at #1222, the network entity 1204 transmits the Nth downlink transmission based on the Nth set of the communication parameters. Again, interference at particular satellite, CPE, or other wireless communication device may therefore be mitigated, facilitating coexistence with such a device.

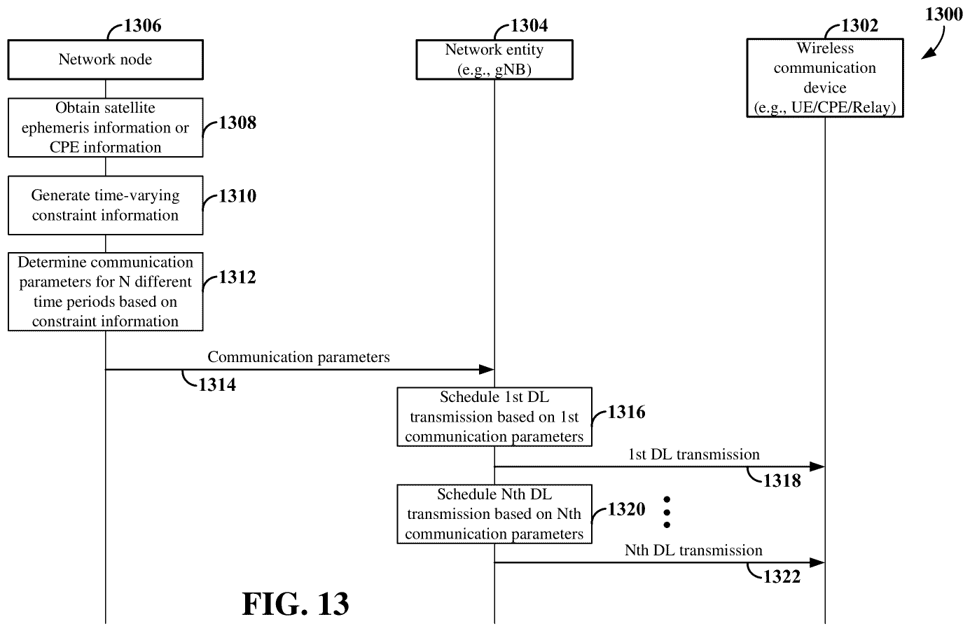

FIG. 13 is a signaling diagram 1300 illustrating another example of coexistence related signaling in a wireless communication system including a wireless communication device 1302, a network entity 1304, and network node 1306 (e.g., a core network node). In this example, the network node 1306 determines time-varying communication parameters based on time-varying constraint information and sends the communication parameters to the network entity 1304.

In some examples, the wireless communication device 1302 may correspond to any of the UEs, CPEs, relay devices, or scheduled entities shown in any of FIGS. 1, 2, 3, 5, 6, 7, 8, 9, 12, 14, 15, and 16. In some examples, the network entity 1304 may correspond to any of the network entities, base stations, CUs, DUs, RUs, or scheduling entities shown in any of FIGS. 1, 2, 3, 5, 6, 7, 8, 9, 12, 14, 15, and 19. In some examples, the network node 1306 may correspond to any of the core network entities, external data network entities, and so on, shown in any of FIGS. 1, 3, 7, 8, 9, 12, 14, and 15.

At #1308 of FIG. 13, the network node 1306 may obtain satellite ephemeris information, CPE information, or other information that indicates one or more time-varying communication aspects of one or more satellites, one or more CPEs, or some other wireless communication entity or entities. In some aspects, the operations of #1308 may be similar to the operations of #1208 discussed above in conjunction with FIG. 12.

At #1310, the network node 1306 may generate time-varying constraint information associated with a satellite, a CPE, etc., based on the information obtained at #1308. In some aspects, the operations of #1310 may be similar to the operations of #1210 discussed above in conjunction with FIG. 12.

At #1312, the network node 1306 determines time-varying communication parameters (e.g., settings, attributes, etc.) to be used for different time periods based on the time-varying constraint information determined at #1310. For example, the network node 1306 may determine a first set of communication parameters to be used by the network entity 1304 during a first time period, a second set of communication parameters to be used by the network entity 1304 during a second time period, and so on.

As discussed above, these communication parameters may include, for example, one of more of a beamforming mode, a beamformer, a beamforming codebook, an antenna configuration, antenna element tilt information, an antenna radiation pattern, a transmit power, a bandwidth, and so on to be used by the network entity 1304 during certain time periods. For example, the network node 1306 may specify a switch from an analog beamforming mode to a digital beamforming mode during a certain period of time to ensure that potential side lobe interference from the network entity 1304 as seen by a particular satellite, CPE, etc., (e.g., a satellite at a particular direction relative to the network entity 1304, using a particular frequency band, and having a particular antenna orientation) is below a maximum interference level specified for that satellite, CPE, etc., during that time period on a particular frequency band (e.g., corresponding to a particular BWP). As another example, the network node 1306 may specify a switch to the use of a different beamforming codebook during that time period to reduce potential interference from the network node 1306 at the satellite, CPE, etc. As a further example, the network node 1306 may specify a change to one or more antenna settings (e.g., activate or deactivate a particular antenna, antenna panel, or antenna element; change the tilt of a particular antenna, antenna panel, or antenna element; and so on) to reduce potential interference from the network node 1306 at the satellite, CPE, etc. As yet another example, the network node 1306 may specify a reduction in transmit power or the use of a different frequency band during the time period to reduce potential interference from the network node 1306 at the satellite, CPE, etc. Other communication parameters may be specified or adjusted in other examples to achieve a similar result.

At #1314, the network node 1306 sends the time-varying communication parameters to the network entity 1304. For example, the network node 1306 may send this information as a look-up table, as a data set, or in some other form.

At #1316, the network entity 1304 schedules a first downlink transmission (e.g., that is to occur during a first time period) to the wireless communication device 1302 based on a first set of the communication parameters (corresponding to the first time period) received at #1314. For example, the network entity 1304 may indicate to the wireless communication device 1302 (e.g., in a DCI) beam information (e.g., antenna ports, TCI state, etc.), frequency information (e.g., a frequency domain resource assignment (FDRA), BWP indicator, etc.), and so on for the first downlink transmission based on the first set of the communication parameters received at #1314.

At #1318, the network entity 1304 transmits the first downlink transmission based on the first set of the communication parameters. For example, as discussed above, the network entity 1304 may use, for the first transmission, one or more of a particular beamforming mode, a particular beamforming codebook, particular antenna settings, a particular transmit power, etc., based on the first set of the communication parameters received at #1314 for the first time period. Thus, interference at particular satellite, CPE, or other wireless communication device may be mitigated, facilitating coexistence with such a device.

The network entity 1304 may then continue to use the communication parameters received at #1314 for subsequent transmissions during the first time period and during any other time periods covered by these communication parameters. For example, for an Nth time period, at #1320, the network entity 1304 schedules an Nth downlink transmission to the wireless communication device 1302 based on an Nth set of the communication parameters received at #1314. Then, at #1322, the network entity 1304 transmits the Nth downlink transmission based on the Nth set of the communication parameters received at #1314. Again, interference at particular satellite, CPE, or other wireless communication device may therefore be mitigated, facilitating coexistence with such a device.

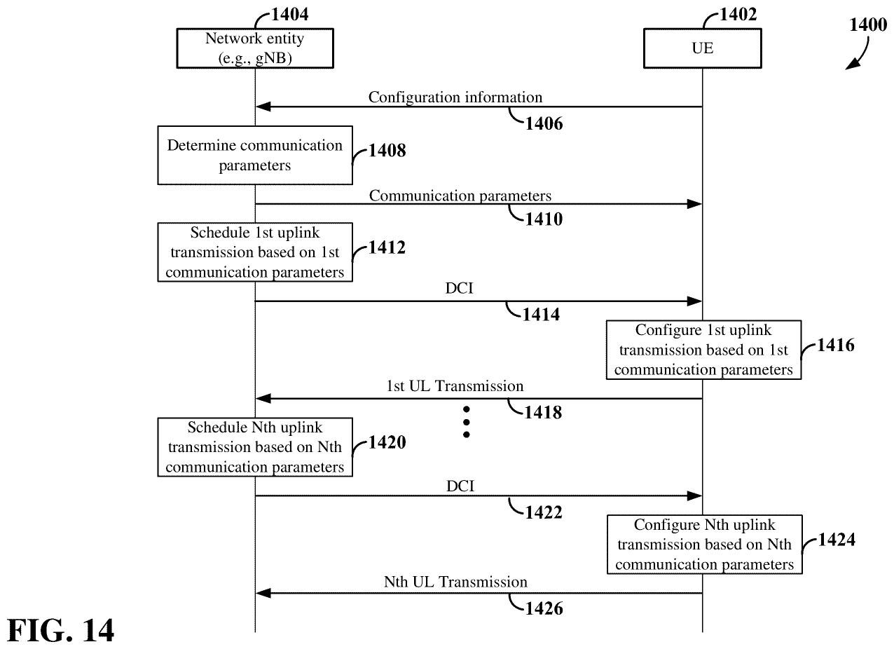

FIG. 14 is a signaling diagram 1400 illustrating an example of coexistence related signaling in a wireless communication system including a UE 1402 and a network entity 1404. In this example, the network entity 1404 obtains time varying communication parameters (e.g., the network entity 1404 receives these parameters as discussed in FIG. 13 or generates these parameters as discussed in FIG. 12) and sends the time varying communication parameters to the UE 1402. The UE 1402 then uses these parameters for its transmissions. In this way, potential interference (caused by transmissions from the UE 1402) at a satellite, a CPE, or some other wireless communication device may be mitigated.

In some examples, the UE 1402 may correspond to any of the UEs, CPEs, relay devices, or scheduled entities shown in any of FIGS. 1, 2, 3, 5, 6, 7, 8, 9, 12, 13, 15, and 16. In some examples, the network entity 1204 may correspond to any of the network entities, base stations, CUs, DUs, RUs, or scheduling entities shown in any of FIGS. 1, 2, 3, 5, 6, 7, 8, 9, 12, 13, 15, and 19.

At optional #1406 of FIG. 14, the UE 1402 may send configuration information (e.g., a capability message) to the network entity 1404. In some examples, the configuration information may indicate one or more communication parameters that are configurable at the UE 1402. For example, the configuration information may indicate that the UE 1402 is able to selectively change one or more antenna settings (e.g., activate or deactivate a particular antenna, antenna panel, or antenna element; change the tilt of a particular antenna, antenna panel, or antenna element; and so on), a radiation pattern, and so on.

At #1408 of FIG. 14, the network entity 1404 may determine one or more time-varying communication parameters for transmissions by the UE 1402. As discussed above at FIGS. 12 and 13, the network entity 1404 may receive time-varying constraint information or time-varying communication parameters from a network node.

In a scenario where the network entity 1404 receives time-varying constraint information from a network node, the network entity 1404 may generate time-varying communication parameters (e.g., settings, attributes, etc.) to be used by the UE 1402 for different time periods based on the received time-varying constraint information. For example, the network entity 1404 may determine a first set of communication parameters to be used by the UE 1402 during a first time period, a second set of communication parameters to be used by the UE 1402 during a second time period, and so on.

In a scenario where the network entity 1404 instead receives time-varying communication parameters from a network node, the network entity 1404 may elect to simply pass this information on to the UE 1402 or the network entity may change at least some of this information.

The time-varying communication parameters may include, for example, one of more of a beamforming mode, a beamformer, a beamforming codebook, an antenna configuration, antenna element tilt information, an antenna radiation pattern, a transmit power, a bandwidth, and so on to be used by the UE 1402 during certain time periods. For example, the communication parameters may specify a switch from an analog beamforming mode to a digital beamforming mode during a certain period of time to ensure that potential side lobe interference from the UE 1402 as seen by a particular satellite, CPE, etc., (e.g., a satellite at a particular direction relative to the UE 1402, using a particular frequency band, and having a particular antenna orientation) is below a maximum interference level specified for that satellite, CPE, etc., during that time period on a particular frequency band (e.g., corresponding to a particular BWP). As another example, the communication parameters may specify a switch to the use of a different beamforming codebook during that time period to reduce potential interference from the UE 1402 at the satellite, CPE, etc. As a further example, the communication parameters may specify a change to one or more antenna settings (e.g., activate/deactivate a particular antenna, antenna panel, or antenna element; change the tilt of a particular antenna, antenna panel, or antenna element; and so on) to reduce potential interference from the UE 1402 at the satellite, CPE, etc. As yet another example, the communication parameters may specify a reduction in transmit power or the use of a different frequency band during the time period to reduce potential interference from the UE 1402 at the satellite, CPE, etc. Other communication parameters may be specified or adjusted in other examples to achieve a similar result.

In some examples, the network entity 1404 may determine time-varying communication parameters based on configuration information received at #1406. For example, upon determining that an antenna setting or a radiation pattern can be changed at the UE 1402 based on the configuration information, the network entity 1404 may specify particular antenna settings, radiation patterns, and so on for different time periods to mitigate potential interference caused by transmissions by the UE 1402 at a satellite, a CPE, or some other wireless communication device.

At #1410, the network entity 1404 sends the time-varying communication parameters to the UE 1402. For example, the network entity 1404 may send this information as a look-up table, as a data set, or in some other form.

At #1412, the network entity 1404 schedules a first uplink transmission (e.g., that is to occur during a first time period) for the UE 1402 based on a first set of the communication parameters (corresponding to the first time period) determined at #1408. For example, the network entity 1404 may indicate to the UE 1402 (e.g., in a DCI 1414) beam information (e.g., antenna ports, etc.), frequency information (e.g., a frequency domain resource assignment (FDRA), BWP indicator, etc.), and so on for the first uplink transmission based on the first set of the communication parameters.

At #1416, the UE 1418 may configure the first uplink transmission based on the DCI 1414 and/or the first set of the communication parameters received at #1410. For example, the UE 1402 may use, for the first uplink transmission at #1418, one or more of a particular beamforming mode, a particular beamforming codebook, particular antenna settings, a particular radiation pattern, a particular transmit power, etc., during the first time period. Thus, interference at particular satellite, CPE, or other wireless communication device may be mitigated, facilitating coexistence with such a device.

The network entity 1404 and the UE 1402 may then continue to use the time-varying communication parameters for subsequent uplink transmissions during the first time period and during any other time periods covered by these communication parameters. For example, for an Nth time period, at #1420, the network entity 1404 schedules an Nth uplink transmission for the UE 1402 based on an Nth set of the communication parameters and sends a corresponding DCI 1422 to the UE 1402. At #1424, the UE 1418 may configure the Nth uplink transmission based on the DCI 1422 and/or the Nth set of the communication parameters received at #1410, and then transmit the Nth downlink transmission at #1426. Again, interference at particular satellite, CPE, or other wireless communication device may therefore be mitigated, facilitating coexistence with such a device.

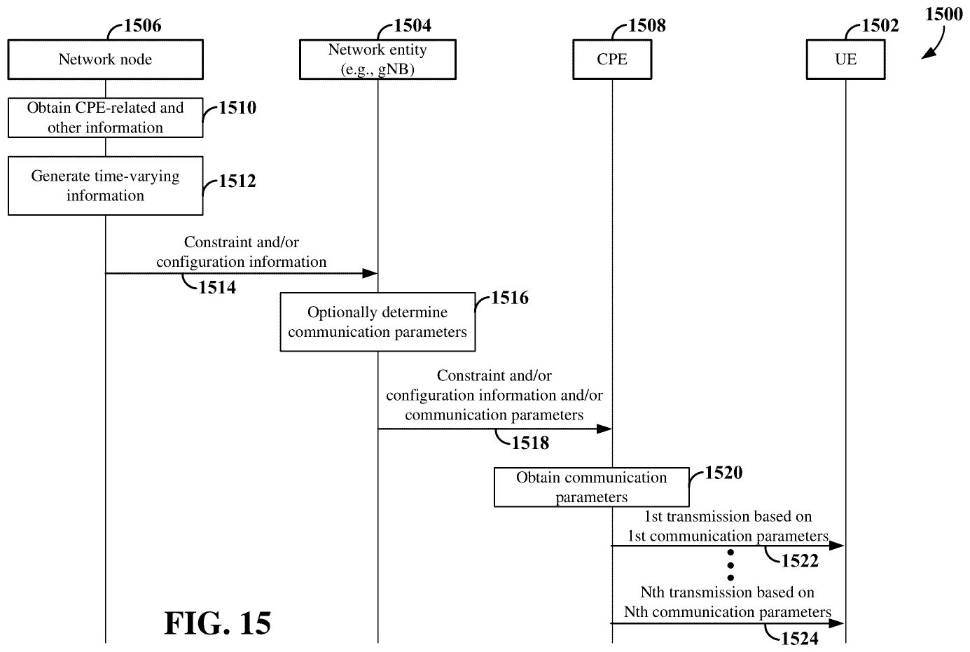

FIG. 15 is a signaling diagram 1500 illustrating an example of coexistence related signaling in a wireless communication system including a UE 1502, a network entity 1504, a network node 1506, and a CPE 1508. In this example, the network entity 1504 and/or the CPE 1508 determines time varying communication parameters that are used by the CPE 1508 for its transmissions. In this way, potential interference (caused by transmissions from the CPE 1508) at a satellite, a network entity, another CPE, or some other wireless communication device may be mitigated. A CPE may take different forms in different examples. For example, a CPE may be a small cell (e.g., deployed in a home, in an office, etc.), a repeater, or some other type of similar wireless communication device.

In some examples, the UE 1502 may correspond to any of the UEs, relay devices, or scheduled entities shown in any of FIGS. 1, 2, 3, 5, 6, 7, 8, 9, 12, 13, 14, and 16. In some examples, the network entity 1204 may correspond to any of the network entities, base stations, CUs, DUs, RUs, or scheduling entities shown in any of FIGS. 1, 2, 3, 5, 6, 7, 8, 9, 12, 13, 14, and 19. In some examples, the network node 1506 may correspond to any of the core network entities, external data network entities, and so on, shown in any of FIGS. 1, 3, 7, 8, 9, 12, 13, and 14. In some examples, the CPE 1508 may correspond to any of the CPEs, relay devices, or scheduled entities shown in any of FIGS. 1, 2, 3, 5, 6, 7, 8, 9, 12, 13, 14, and 16.

At #1510 of FIG. 15, the network node 1506 may obtain CPE information or other information that indicates one or more time-varying communication aspects of one or more CPEs. For example, a network entity that serves a CPE may maintain (e.g., regularly update, as needed) information regarding periods of time the CPE is operating, frequency bands used by the CPE (e.g., at various points in time), the orientation of the CPE's antenna(s) at various points in time, and so on. In this case, the network node 1506 may obtain this information from the serving network entity or some other entity that has access to this information.

At #1512, the network node 1506 may generate time-varying constraint information associated based on the information obtained at #1510 and/or satellite information and/or other device information (e.g., as obtained at #1208 of FIG. 12). Thus, in some aspects, at least some of the operations of #1512 may be similar to the operations of #1210 discussed above in conjunction with FIG. 12.

In some scenarios, the network node 1506 may determine configuration information related to a particular a CPE. For example, the network node 1506 may determine the details of a CPE backhaul, CPE access beam information, CPE-to-satellite orientation information, and so on.

At #1514, the network node 1506 sends the time-varying constraint information and/or the CPE configuration parameters to the network entity 1504. For example, the network node 1506 may send this information as a look-up table, as a data set, or in some other form.

At optional #1516, the network entity 1504 may determine time-varying communication parameters (e.g., settings, attributes, etc.) to be used by the CPE 1508 for different time periods based on the time-varying constraint information and/or configuration information received at #1514. For example, the network entity 1504 may determine a first set of communication parameters to be used during a first time period, a second set of communication parameters to be used during a second time period, and so on.

The time-varying communication parameters may include, for example, one of more of a beamforming mode, a beamformer, a beamforming codebook, an antenna configuration, antenna element tilt information, an antenna radiation pattern, a transmit power, a bandwidth, and so on to be used by the CPE 1508 during certain time periods. For example, the communication parameters may specify a switch from an analog beamforming mode to a digital beamforming mode during a certain period of time to ensure that potential side lobe interference from the CPE 1508 as seen by a particular satellite, etc., (e.g., a satellite at a particular direction relative to the CPE 1508, using a particular frequency band, and having a particular antenna orientation) is below a maximum interference level specified for that satellite, etc., during that time period on a particular frequency band (e.g., corresponding to a particular BWP). As another example, the communication parameters may specify a switch to the use of a different beamforming codebook during that time period to reduce potential interference from the CPE 1508 at the satellite, etc. As a further example, the communication parameters may specify a change to one or more antenna settings (e.g., activate/deactivate a particular antenna, antenna panel, or antenna element; change the tilt of a particular antenna, antenna panel, or antenna element; and so on) to reduce potential interference from the CPE 1508 at the satellite, CPE, etc. As yet another example, the communication parameters may specify a reduction in transmit power or the use of a different frequency band during the time period to reduce potential interference from the CPE 1508 at the satellite, etc. Other communication parameters may be specified or adjusted in other examples to achieve a similar result.

At #1518, the network entity 1504 sends the time-varying constraint information and/or the CPE configuration information and/or the time-varying communication parameters to the CPE 1508. For example, the network node 1506 may send this information as a look-up table, as a data set, or in some other form.

At #1520, the CPE 1508 obtains time-varying communication parameters (e.g., settings, attributes, etc.) to be used by the CPE 1508 for different time periods. In some scenarios, the CPE 1508 may receive some or all of this information directly from the network entity 1504. In some scenarios, the CPE 1508 may generate this information based on time-varying constraint information and/or CPE configuration information received at #1518. For example, the CPE 1508 may determine a first set of communication parameters to be used during a first time period, a second set of communication parameters to be used during a second time period, and so on.

At #1522, the CPE 1508 transmits a first transmission (e.g., that is to occur during a first time period) to the UE 1502 based on a first set of the communication parameters (corresponding to the first time period) obtained at #1520. For example, the CPE 1508 may use, for the first transmission, one or more of a particular beamforming mode, a particular beamforming codebook, particular antenna settings, a particular transmit power, etc., for the first time period. Thus, interference at particular satellite, or other wireless communication device may be mitigated, facilitating coexistence with such a device.

The CPE 1508 may then continue to use the communication parameters obtained at #1520 for subsequent transmissions during the first time period and during any other time periods covered by these communication parameters. For example, for an Nth time period, at #1524, the CPE 1508 transmits an Nth transmission based on the Nth set of the communication parameters. Again, interference at particular satellite, or other wireless communication device may therefore be mitigated, facilitating coexistence with such a device.

In some examples, one or more of the operations of FIGS. 12-15 may be used together to facilitate coexistence (e.g., a network entity may control its transmissions and also instruct another device to control its transmissions). In view of the above, the disclosure relates in some aspects to an apparatus configured for wireless communication that includes memories, processors and instructions, which cause the apparatus to: obtain from a network node, a look-up-table as per a configured time-schedule; retrieve from the look-up-table a set of parameters; infer from parameters, a set of requirements for ensuring coexistence with an incumbent system operating on shared spectrum; translate inferred requirements to updated communications attributes according to the inferred requirements; perform communications according to the updated communications attributes. In some examples, the communications attributes include at-least one of: a set of beamforming modes; a set of beamforming codebooks; antenna array tilts; antenna element radiation patterns; transmit powers or bandwidth parts. In some examples, the incumbent system includes one or more satellites. In some examples, the incumbent system includes one or more CPEs, relay devices, or forwarding devices.

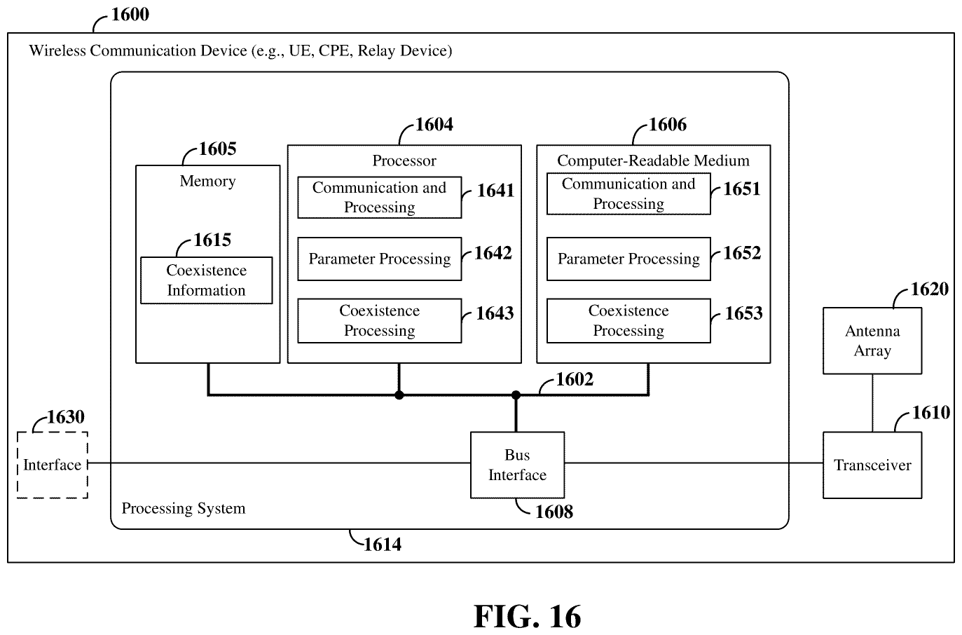

FIG. 16 is a block diagram illustrating an example of a hardware implementation for a wireless communication device 1600 employing a processing system 1614. In some examples, the wireless communication device 1600 may be a device configured to wirelessly communicate with a network entity, as discussed in any one or more of FIGS. 1, 2, 3, 5, 6, 7, 8, 9, 12, 13, 14, and 15. In some implementations, the wireless communication device 1600 may correspond to any of the UEs, CPEs, relay devices, or scheduled entities shown in any of FIGS. 1, 2, 3, 5, 6, 7, 8, 9, 12, 13, 14, and 15.

In accordance with various aspects of the disclosure, an element, or any portion of an element, or any combination of elements may be implemented with the processing system 1614. The processing system 1614 may include one or more processors 1604. Examples of processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1600 may be configured to perform any one or more of the functions described herein. That is, the processor 1604, as utilized in a wireless communication device 1600, may be used to implement any one or more of the processes and procedures described herein.

The processor 1604 may in some instances be implemented via a baseband or modem chip and in other implementations, the processor 1604 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In some examples, (e.g., if the wireless communication device 1600 is a CPE or is capable of scheduling SL communication), the processor 1604 may be configured to generate, schedule, and modify a resource assignment or grant of time-frequency resources (e.g., a set of one or more resource elements). For example, the processor 1604 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1604 may be configured to schedule resources for the transmission of downlink signals. The processor 1604 may further be configured to schedule resources for the transmission of uplink signals.

In this example, the processing system 1614 may be implemented with a bus architecture, represented generally by the bus 1602. The bus 1602 may include any number of interconnecting buses and bridges depending on the specific application of the processing system 1614 and the overall design constraints. The bus 1602 communicatively couples together various circuits including one or more processors (represented generally by the processor 1604), a memory 1605, and computer-readable media (represented generally by the computer-readable medium 1606). The bus 1602 may also link various other circuits such as timing sources, peripherals, voltage regulators, and power management circuits, which are well known in the art, and therefore, will not be described any further. A bus interface 1608 provides an interface between the bus 1602, a transceiver 1610 and an antenna array 1620 and between the bus 1602 and an interface 1630. The transceiver 1610 provides a communication interface or means for communicating with various other apparatus over a wireless transmission medium. The interface 1630 provides a communication interface or means of communicating with various other apparatuses and devices (e.g., other devices housed within the same apparatus as the wireless communication device 1600 or other external apparatuses) over an internal bus or external transmission medium, such as an Ethernet cable. Depending upon the nature of the apparatus, the interface 1630 may include a user interface (e.g., keypad, display, speaker, microphone, joystick). Of course, such a user interface is optional, and may be omitted in some examples, such as an IoT device.

The processor 1604 is responsible for managing the bus 1602 and general processing, including the execution of software stored on the computer-readable medium 1606. The software, when executed by the processor 1604, causes the processing system 1614 to perform the various functions described below for any particular apparatus. The computer-readable medium 1606 and the memory 1605 may also be used for storing data that is manipulated by the processor 1604 when executing software. For example, the memory 1605 may store coexistence information 1615 (e.g., interference information, communication parameters, and so on) used by the processor 1604 for the communication operations described herein.

One or more processors 1604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1606.

The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may reside in the processing system 1614, external to the processing system 1614, or distributed across multiple entities including the processing system 1614. The computer-readable medium 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

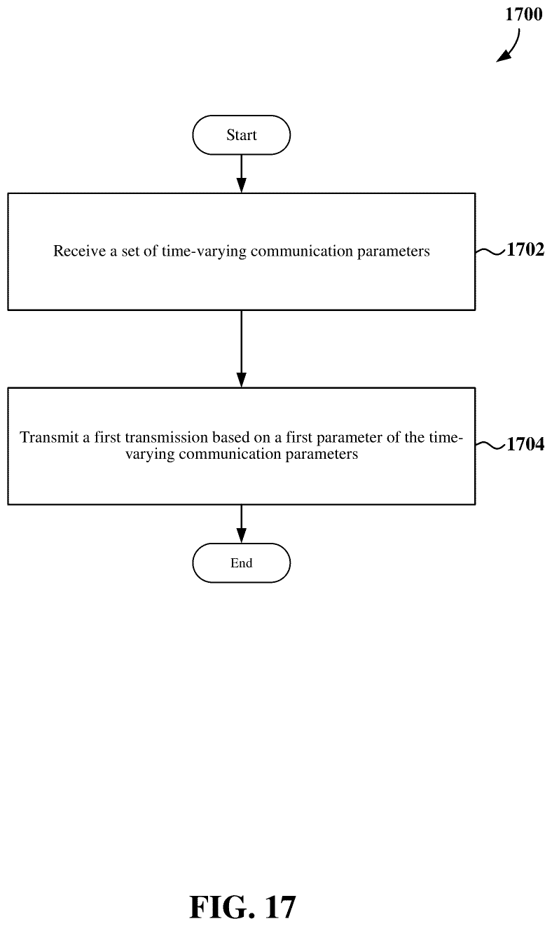

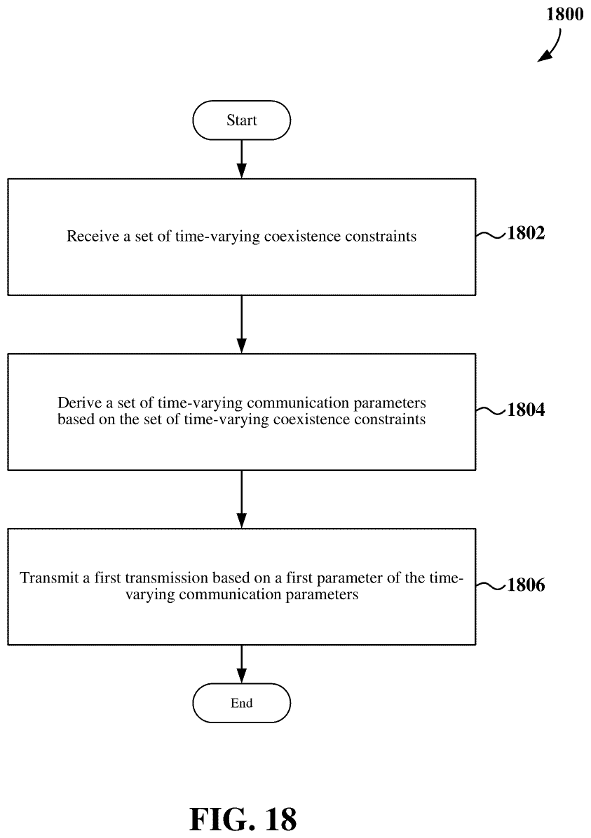

The wireless communication device 1600 may be configured to perform any one or more of the operations described herein (e.g., as described above in conjunction with FIGS. 1-15 and as described below in conjunction with FIGS. 17 and 18). In some aspects of the disclosure, the processor 1604, as utilized in the wireless communication device 1600, may include circuitry configured for various functions.

The processor 1604 may include communication and processing circuitry 1641. The communication and processing circuitry 1641 may be configured to communicate with a network entity, such as a gNB. The communication and processing circuitry 1641 may be configured to communicate with a base station and one or more other wireless communication devices over a common carrier shared between a cellular (e.g., Uu) interface and a sidelink (e.g., PC5) interface. The communication and processing circuitry 1641 may include one or more hardware components that provide the physical structure that performs various processes related to wireless communication (e.g., signal reception and/or signal transmission) as described herein. The communication and processing circuitry 1641 may further include one or more hardware components that provide the physical structure that performs various processes related to signal processing (e.g., processing a received signal and/or processing a signal for transmission) as described herein. In some examples, the communication and processing circuitry 1641 may include two or more transmit/receive chains (e.g., one chain to communicate with a base station and another chain to communicate with a sidelink device). The communication and processing circuitry 1641 may further be configured to execute communication and processing software 1651 included on the computer-readable medium 1606 to implement one or more functions described herein.

In some implementations where the communication involves receiving information, the communication and processing circuitry 1641 may obtain information from a component of the wireless communication device 1600 (e.g., from the transceiver 1610 that receives the information via radio frequency signaling or some other type of signaling suitable for the applicable communication medium), process (e.g., decode) the information, and output the processed information. For example, the communication and processing circuitry 1641 may output the information to another component of the processor 1604, to the memory 1605, or to the bus interface 1608. In some examples, the communication and processing circuitry 1641 may receive one or more of signals, messages, other information, or any combination thereof. In some examples, the communication and processing circuitry 1641 may receive information via one or more channels. In some examples, the communication and processing circuitry 1641 may receive one or more of signals, messages, SCIs, feedback, other information, or any combination thereof. In some examples, the communication and processing circuitry 1641 may receive information via one or more of a PSCCH, a PSSCH, a PSFCH, some other type of channel, or any combination thereof. In some examples, the communication and processing circuitry 1641 may include functionality for a means for receiving (e.g., receiving parameters, receiving constraints, etc.). In some examples, the communication and processing circuitry 1641 may include functionality for a means for decoding.

In some implementations where the communication involves sending (e.g., transmitting) information, the communication and processing circuitry 1641 may obtain information (e.g., from another component of the processor 1604, the memory 1605, or the bus interface 1608), process (e.g., encode) the information, and output the processed information. For example, the communication and processing circuitry 1641 may output the information to the transceiver 1610 (e.g., that transmits the information via radio frequency signaling or some other type of signaling suitable for the applicable communication medium). In some examples, the communication and processing circuitry 1641 may send one or more of signals, messages, other information, or any combination thereof. In some examples, the communication and processing circuitry 1641 may send information via one or more channels. In some examples, the communication and processing circuitry 1641 may send one or more of signals, messages, SCIs, feedback, other information, or any combination thereof. In some examples, the communication and processing circuitry 1641 may send information via one or more of a PSCCH, a PSSCH, a PSFCH, some other type of channel, or any combination thereof. In some examples, the communication and processing circuitry 1641 may include functionality for a means for transmitting (e.g., transmitting a first transmission). In some examples, the communication and processing circuitry 1641 may include functionality for a means for encoding.

The processor 1604 may include parameter processing circuitry 1642 configured to perform parameter processing-related operations as discussed herein (e.g., one or more of the operations described above in conjunction with FIGS. 7-15). The parameter processing circuitry 1642 may be configured to execute parameter processing software 1652 included on the computer-readable medium 1606 to implement one or more functions described herein.

The parameter processing circuitry 1642 may include functionality for a means for receiving (e.g., as described above in conjunction with FIGS. 7-15). For example, the parameter processing circuitry 1642 may cooperate with the communication and processing circuitry 1641 to receive a message or other information from a network entity (e.g., via a PDSCH or a PDCCH). This information may include, for example, a set of time-varying coexistence constraints, a set of time-varying communication parameters, or a message including a parameter set and associated time schedule.

The parameter processing circuitry 1642 may include functionality for a means for transmitting (e.g., as described above in conjunction with FIGS. 7-15). For example, the parameter processing circuitry 1642 may cooperate with the communication and processing circuitry 1641 to transmit a message to a network entity or some other device (e.g., via a PUSCH or a PUCCH). As a further example, the parameter processing circuitry 1642 may cooperate with the communication and processing circuitry 1641 to transmit capability and/or configuration information to a network entity or some other device.

The parameter processing circuitry 1642 may include functionality for a means for selecting or deriving (e.g., as described above in conjunction with FIGS. 7-15). For example, the parameter processing circuitry 1642 may select at least one wireless communication parameter. In some examples, this selection may involve identifying a set of requirements. In some examples, the at least one wireless communication parameter may include restrictions on communication settings. As another example, the parameter processing circuitry 1642 may derive a set of time-varying communication parameters based on a set of time-varying coexistence constraints.

The coexistence processing circuitry 1643 may include functionality for a means for switching (e.g., as described above in conjunction with FIGS. 7-15). For example, the coexistence processing circuitry 1643 may invoke of switch, for a component of the wireless communication device 1600, from the use of a first mode, circuitry, information, parameter, etc., to the use of a second mode, circuitry, information, parameter, etc.

The coexistence processing circuitry 1643 may include functionality for a means for adjusting (e.g., as described above in conjunction with FIGS. 7-15). For example, the coexistence processing circuitry 1643 may invoke the adjustment of a transmit power, an antenna tilt, or an antenna radiation pattern.

The coexistence processing circuitry 1643 may include functionality for a means for enabling (e.g., as described above in conjunction with FIGS. 7-15). For example, the coexistence processing circuitry 1643 may enable an antenna, a circuit, a process, or other functionality of the wireless communication device 1600.

The coexistence processing circuitry 1643 may include functionality for a means for disabling (e.g., as described above in conjunction with FIGS. 7-15). For example, the coexistence processing circuitry 1643 may disable an antenna, a circuit, a process, or other functionality of the wireless communication device 1600.

The coexistence processing circuitry 1643 may include functionality for a means for transmitting (e.g., as described above in conjunction with FIGS. 7-15). For example, the coexistence processing circuitry 1643 may cooperate with the communication and processing circuitry 1641 to transmit a message to network entity or some other device (e.g., via a PUSCH or a PUCCH).

The coexistence processing circuitry 1643 may include functionality for a means for receiving (e.g., as described above in conjunction with FIGS. 7-15). For example, the coexistence processing circuitry 1643 may cooperate with the communication and processing circuitry 1641 to receive a message from a network entity or some other device (e.g., via a PDSCH or a PDCCH).

FIG. 17 is a flow chart illustrating an example method 1700 for wireless communication in accordance with some aspects of the present disclosure. As described below, some or all illustrated features may be omitted in a particular implementation within the scope of the present disclosure, and some illustrated features may not be required for implementation of all examples. In some examples, the method 1700 (method for wireless communication) may be carried out by the wireless communication device 1600 illustrated in FIG. 16. In some examples, the method 1700 may be carried out by any suitable apparatus or means for carrying out the functions or algorithm described below.

At block 1702, a first wireless communication may receive a set of time-varying communication parameters. In some examples, the parameter processing circuitry 1642 together with the communication and processing circuitry 1641 and the transceiver 1610, shown and described in FIG. 16, may provide a means to receive a set of time-varying communication parameters.

At block 1704, the first wireless communication may transmit a first transmission based on a first parameter of the time-varying communication parameters. In some examples, the coexistence processing circuitry 1643 together with the communication and processing circuitry 1641 and the transceiver 1610, shown and described in FIG. 16, may provide a means to transmit a first transmission based on a first parameter of the time-varying communication parameters.

In some examples, a mapping of each of a plurality of time periods of a first time schedule with a corresponding subset of a first parameter set maps a first time period of the plurality of time periods with a first subset of the first parameter set. In some examples, the mapping of each of the plurality of time periods of the first time schedule with the corresponding subset of the first parameter set maps a second time period of the plurality of time periods with a second subset of the first parameter set, the second time period being different from the first time period, and the second subset being different from the first subset. In some examples, the transmission of the first transmission is based on the mapping.

In some examples, the first parameter set includes coexistence requirements (e.g., maximum interference levels). In some examples, the first parameter set includes previously translated wireless communication parameters.

In some examples, the mapping of each of the plurality of time periods of the first time schedule with the corresponding subset of the first parameter set may include a look-up table.

In some examples, the first wireless communication device may receive a second message including a second set of time-varying communication parameters (e.g., a second parameter set and a second time schedule). In some examples, the second message further may include an indication of a duration of time during which the second set of time-varying communication parameters are valid.

In some examples, the first parameter indicates at least one of: a wireless communication setting, a wireless communication attribute, a beamforming mode, a beamformer, a beamforming codebook, an antenna array, antenna element tilt information, an antenna radiation pattern, a transmit power, or a bandwidth.

In some examples, based on the first parameter, the first wireless communication device may perform at least one of: switch from a digital beamforming mode to an analog beamforming mode, switch from the analog beamforming mode to the digital beamforming mode, switch from a first beamforming codebook to a second beamforming codebook, switch from a first beamformer to a second beamformer, switch from a first precoder to a second precoder, adjust a transmit power, switch from a first transmit bandwidth to a second transmit bandwidth, enable an antenna or an antenna element, disable the antenna or the antenna element, adjust a tilt of the antenna or the antenna element, or adjust a radiation pattern of the antenna or the antenna element.

FIG. 18 is a flow chart illustrating an example method 1800 for wireless communication in accordance with some aspects of the present disclosure. As described below, some or all illustrated features may be omitted in a particular implementation within the scope of the present disclosure, and some illustrated features may not be required for implementation of all examples. In some examples, the method 1800 (method for wireless communication) may be carried out by the wireless communication device 1600 illustrated in FIG. 16. In some examples, the method 1800 may be carried out by any suitable apparatus or means for carrying out the functions or algorithm described below.

At block 1802, a first wireless communication may receive a set of time-varying coexistence constraints. In some examples, the parameter processing circuitry 1642 together with the communication and processing circuitry 1641 and the transceiver 1610, shown and described in FIG. 16, may provide a means to receive a set of time-varying coexistence constraints.

At block 1804, the first wireless communication may derive a set of time-varying communication parameters based on the set of time-varying coexistence constraints. In some examples, the parameter processing circuitry 1642, shown and described in FIG. 16, may provide a means to derive a set of time-varying communication parameters based on the set of time-varying coexistence constraints.

At block 1806, the first wireless communication may transmit a first transmission based on a first parameter of the time-varying communication parameters. In some examples, the coexistence processing circuitry 1643 together with the communication and processing circuitry 1641 and the transceiver 1610, shown and described in FIG. 16, may provide a means to transmit a first transmission based on a first parameter of the time-varying communication parameters.

Referring again to FIG. 16, in one configuration, the wireless communication device 1600 includes means for receiving a set of time-varying communication parameters, and means for transmitting a first transmission based on a first parameter of the time-varying communication parameters. In one configuration, the wireless communication device 1600 includes means for receiving a set of time-varying coexistence constraints, means for deriving a set of time-varying communication parameters based on the set of time-varying coexistence constraints, and means for transmitting a first transmission based on a first parameter of the time-varying communication parameters. In one aspect, the aforementioned means may be the processor 1604 shown in FIG. 16 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable medium 1606, or any other suitable apparatus or means described in any one or more of FIGS. 1-3, 5-10, and 12-16, and utilizing, for example, the methods and/or algorithms described herein in relation to FIGS. 17 and 18.

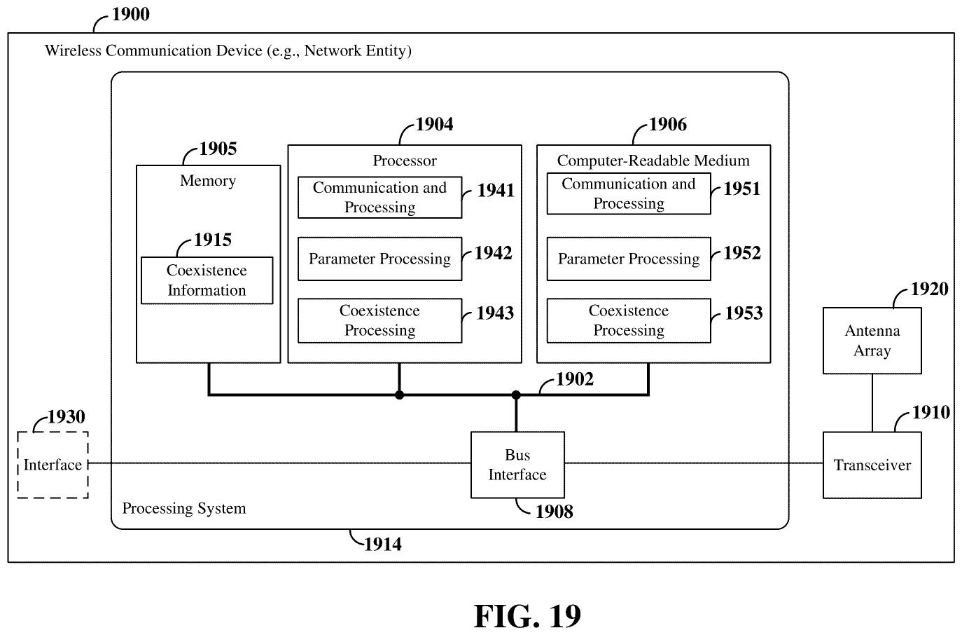

FIG. 19 is a conceptual diagram illustrating an example of a hardware implementation for a wireless communication device 1900 employing a processing system 1914. In some implementations, the wireless communication device 1900 may correspond to any of the base stations, CUs, DUs, RUs, or scheduling entities shown in any of FIGS. 1, 2, 3, 5, 6, 7, 8, 9, 12, 13, 14, and 15.

In accordance with various aspects of the disclosure, an element, or any portion of an element, or any combination of elements may be implemented with the processing system 1914. The processing system may include one or more processors 1904. The processing system 1914 may be substantially the same as the processing system 1614 illustrated in FIG. 16, including a bus interface 1908, a bus 1902, memory 1905, a processor 1904, a computer-readable medium 1906, a transceiver 1910, and an antenna array 1920. The memory 1905 may store coexistence information 1915 (e.g., interference information, communication parameters, and so on) used by the processor 1904 in cooperation with the transceiver 1910 for communication operations as described herein. Furthermore, the wireless communication device 1900 may include an interface 1930 (e.g., a network interface) that provides a means for communicating with at least one other apparatus within a core network and with at least one radio access network.

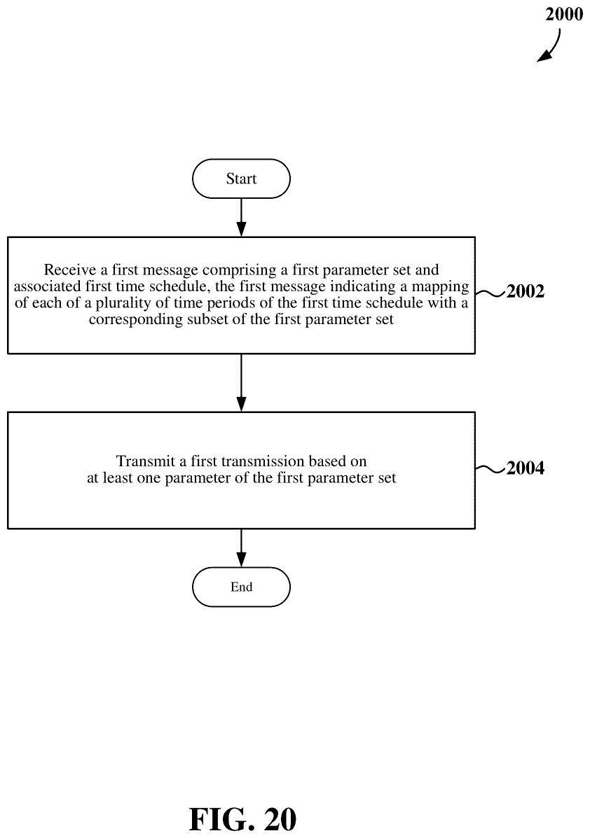

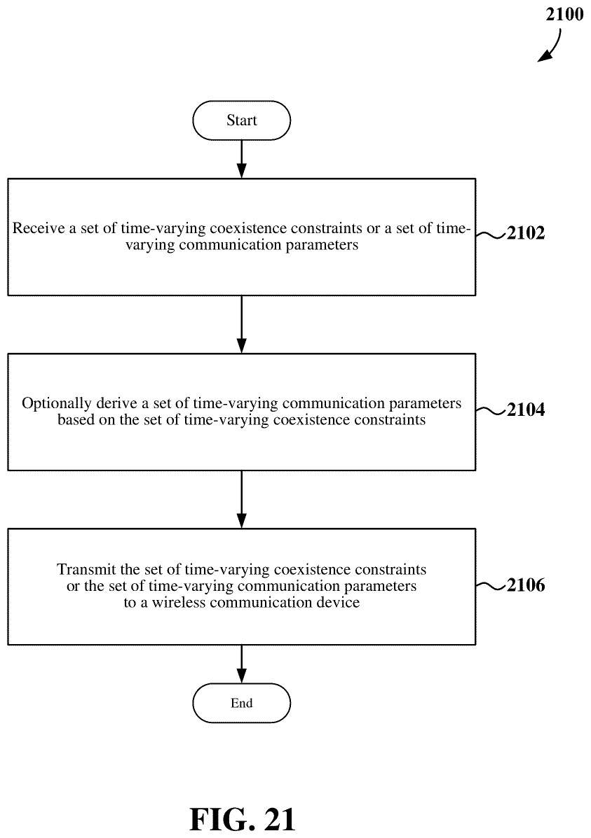

The wireless communication device 1900 may be configured to perform any one or more of the operations described herein (e.g., as described above in conjunction with FIGS. 1-15 and as described below in conjunction with FIGS. 20 and 21). In some aspects of the disclosure, the processor 1904, as utilized in the wireless communication device 1900, may include circuitry configured for various functions.

The processor 1904 may be configured to generate, schedule, and modify a resource assignment or grant of time-frequency resources (e.g., a set of one or more resource elements). For example, the processor 1904 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1904 may be configured to schedule resources for the transmission of downlink signals. The processor 1904 may further be configured to schedule resources for the transmission of uplink signals.

In some aspects of the disclosure, the processor 1904 may include communication and processing circuitry 1941. The communication and processing circuitry 1941 may be configured to communicate with a user equipment. The communication and processing circuitry 1941 may include one or more hardware components that provide the physical structure that performs various processes related to communication (e.g., signal reception and/or signal transmission) as described herein. The communication and processing circuitry 1941 may further include one or more hardware components that provide the physical structure that performs various processes related to signal processing (e.g., processing a received signal and/or processing a signal for transmission) as described herein. The communication and processing circuitry 1941 may further be configured to execute communication and processing software 1951 included on the computer-readable medium 1906 to implement one or more functions described herein.

The communication and processing circuitry 1941 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1941 may further be configured to receive a scheduling request from a UE for an uplink grant or a sidelink grant.

In some implementations wherein the communication involves receiving information, the communication and processing circuitry 1941 may obtain information from a component of the wireless communication device 1900 (e.g., from the transceiver 1910 that receives the information via radio frequency signaling or some other type of signaling suitable for the applicable communication medium), process (e.g., decode) the information, and output the processed information. For example, the communication and processing circuitry 1941 may output the information to another component of the processor 1904, to the memory 1905, or to the bus interface 1908. In some examples, the communication and processing circuitry 1941 may receive one or more of signals, messages, other information, or any combination thereof. In some examples, the communication and processing circuitry 1941 may receive information via one or more channels. In some examples, the communication and processing circuitry 1941 may include functionality for a means for receiving (e.g., receiving messages, parameters, constraints, etc.). In some examples, the communication and processing circuitry 1941 may include functionality for a means for decoding.

In some implementations wherein the communication involves sending (e.g., transmitting) information, the communication and processing circuitry 1941 may obtain information (e.g., from another component of the processor 1904, the memory 1905, or the bus interface 1908), process (e.g., encode) the information, and output the processed information. For example, the communication and processing circuitry 1941 may output the information to the transceiver 1910 (e.g., that transmits the information via radio frequency signaling or some other type of signaling suitable for the applicable communication medium). In some examples, the communication and processing circuitry 1941 may send one or more of signals, messages, other information, or any combination thereof. In some examples, the communication and processing circuitry 1941 may send information via one or more channels. In some examples, the communication and processing circuitry 1941 may include functionality for a means for transmitting (e.g., transmitting a first transmission, parameters, constraints, etc.). In some examples, the communication and processing circuitry 1941 may include functionality for a means for encoding.

The processor 1904 may include parameter processing circuitry 1942 configured to perform parameter processing-related operations as discussed herein (e.g., one or more of the operations described above in conjunction with FIGS. 7-15). The parameter processing circuitry 1942 may be configured to execute parameter processing software 1952 included on the computer-readable medium 1906 to implement one or more functions described herein.

The parameter processing circuitry 1942 may include functionality for a means for receiving (e.g., as described above in conjunction with FIGS. 7-15). For example, the parameter processing circuitry 1942 may cooperate with the communication and processing circuitry 1941 to receive information from a network node. This information may include, for example, a set of time-varying coexistence constraints, a set of time-varying communication parameters, or a message including a parameter set and associated time schedule. As another example, the parameter processing circuitry 1942 may cooperate with the communication and processing circuitry 1941 to receive a message from a UE, a CPE, or some other device (e.g., via a PUSCH or a PUCCH). As a further example, the parameter processing circuitry 1942 may cooperate with the communication and processing circuitry 1941 to receive capability and/or configuration information from a UE, a CPE, or some other device.

The parameter processing circuitry 1942 may include functionality for a means for transmitting (e.g., as described above in conjunction with FIGS. 7-15). For example, the parameter processing circuitry 1942 may cooperate with the communication and processing circuitry 1941 to transmit a message to a UE, a CPE, or some other device (e.g., via a PDSCH or a PDCCH). This information may include, for example, a set of time-varying coexistence constraints, a set of time-varying communication parameters, or a message including a parameter set and associated time schedule.

The parameter processing circuitry 1942 may include functionality for a means for selecting or deriving (e.g., as described above in conjunction with FIGS. 7-15). For example, the parameter processing circuitry 1942 may cooperate with the communication and processing circuitry 1941 to select at least one wireless communication parameter. In some examples, this selection may involve identifying a set of requirements. In some examples, the at least one wireless communication parameter may include restrictions on communication settings. As another example, the parameter processing circuitry 1942 may derive a set of time-varying communication parameters based on a set of time-varying coexistence constraints.

The coexistence processing circuitry 1943 may include functionality for a means for switching (e.g., as described above in conjunction with FIGS. 7-15). For example, the coexistence processing circuitry 1943 may invoke of switch, for a component of the wireless communication device 1900, from the use of a first mode, circuitry, information, parameter, etc., to the use of a second mode, circuitry, information, parameter, etc.

The coexistence processing circuitry 1943 may include functionality for a means for adjusting (e.g., as described above in conjunction with FIGS. 7-15). For example, the coexistence processing circuitry 1943 may invoke the adjustment of a transmit power, an antenna tilt, or an antenna radiation pattern.

The coexistence processing circuitry 1943 may include functionality for a means for enabling (e.g., as described above in conjunction with FIGS. 7-15). For example, the coexistence processing circuitry 1943 may enable an antenna, a circuit, a process, or other functionality of the wireless communication device 1900.

The coexistence processing circuitry 1943 may include functionality for a means for disabling (e.g., as described above in conjunction with FIGS. 7-15). For example, the coexistence processing circuitry 1943 may disable an antenna, a circuit, a process, or other functionality of the wireless communication device 1900.

The coexistence processing circuitry 1943 may include functionality for a means for transmitting (e.g., as described above in conjunction with FIGS. 7-15). For example, the coexistence processing circuitry 1943 may cooperate with the communication and processing circuitry 1941 to transmit a message to a UE, a CPE, or some other device (e.g., via a PDSCH or a PDCCH).

The coexistence processing circuitry 1943 may include functionality for a means for receiving (e.g., as described above in conjunction with FIGS. 7-15). For example, the coexistence processing circuitry 1943 may cooperate with the communication and processing circuitry 1941 to receive a message from a UE, a CPE, or some other device (e.g., via a PUSCH or a PUCCH).

In some examples, the wireless communication device 1900 shown and described above in connection with FIG. 19 may be a disaggregated base station. For example, the wireless communication device 1900 shown in FIG. 19 may include the CU and optionally one or more DUs/RUs of the disaggregated base station. Other DUs/RUs associated with the wireless communication device 1900 may be distributed throughout the network. In some examples, the DUs/RUs may correspond to TRPs associated with the network entity. In some examples, the CU and/or DU/RU of the disaggregated base station (e.g., within the wireless communication device 1900) may generate information and provide the information to a user equipment, as well as receive and process messages from the user equipment.

FIG. 20 is a flow chart illustrating an example method 2000 for wireless communication in accordance with some aspects of the present disclosure. As described below, some or all illustrated features may be omitted in a particular implementation within the scope of the present disclosure, and some illustrated features may not be required for implementation of all examples. In some examples, the method 2000 may be carried out by the wireless communication device 1900 illustrated in FIG. 19. In some examples, the method 2000 may be carried out by any suitable apparatus or means for carrying out the functions or algorithm described below.

At block 2002, a first wireless communication device may receive a first message including a first parameter set and associated first time schedule, the first message indicating a mapping of each of a plurality of time periods of the first time schedule with a corresponding subset of the first parameter set. In some examples, the parameter processing circuitry 1942 together with the communication and processing circuitry 1941 and the transceiver 1910, shown and described in FIG. 19, may provide a means to receive a first message including a first parameter set and associated first time schedule, the first message indicating a mapping of each of a plurality of time periods of the first time schedule with a corresponding subset of the first parameter set.

At block 2004, the first wireless communication device may transmit a first transmission based on at least one parameter of the first parameter set. In some examples, the coexistence processing circuitry 1943 together with the communication and processing circuitry 1941 and the transceiver 1910, shown and described in FIG. 19, may provide a means to transmit a first transmission based on at least one parameter of the first parameter set.

In some examples, the first parameter set includes coexistence requirements. In some examples, the first parameter set includes previously translated wireless communication parameters.

In some examples, the mapping of each of the plurality of time periods of the first time schedule with the corresponding subset of the first parameter set maps a first time period of the plurality of time periods with a first subset of the first parameter set. In some examples, the mapping of each of the plurality of time periods of the first time schedule with the corresponding subset of the first parameter set maps a second time period of the plurality of time periods with a second subset of the first parameter set, the second time period being different from the first time period, and the second subset being different from the first subset.

In some examples, the mapping of each of the plurality of time periods of the first time schedule with the corresponding subset of the first parameter set may include a look-up table.

In some examples, the first wireless communication device may receive a second message including a second parameter set and associated second time schedule to at least temporarily supersede the first parameter set and the first time schedule. In some examples, the first wireless communication device may transmit a second transmission based on at least one parameter of the second parameter set. In some examples, the second message further may include an indication of a duration of time during which the second parameter set and the second time schedule are valid.

In some examples, the first parameter set (e.g., coexistence requirements) may include at least one of: a wireless communication coexistence parameter, an interference level, or an indication of a direction between the first wireless communication device and a second wireless communication device. In some examples, the second wireless communication device may include a satellite, a customer premises equipment, or a relay device.

In some examples, the first wireless communication device may select at least one wireless communication parameter (e.g., restrictions on communication settings) for the first transmission based on the at least one parameter of the first parameter set (e.g., coexistence parameters such as coexistence requirements). In some examples, the transmission of the first transmission based on the at least one parameter of the first parameter set may include a transmission based on the at least one wireless communication parameter.

In some examples, the at least one wireless communication parameter indicates at least one of: a wireless communication setting, a wireless communication attribute, a beamforming mode, a beamformer, a beamforming codebook, an antenna array, antenna element tilt information, an antenna radiation pattern, a transmit power, or a bandwidth.

In some examples, based on the at least one wireless communication parameter, the first wireless communication device may perform at least one of: switch from a digital beamforming mode to an analog beamforming mode, switch from the analog beamforming mode to the digital beamforming mode, switch from a first beamforming codebook to a second beamforming codebook, switch from a first beamformer to a second beamformer, switch from a first precoder to a second precoder, adjust a transmit power, switch from a first transmit bandwidth to a second transmit bandwidth, enable an antenna or an antenna element, disable the antenna or the antenna element, adjust a tilt of the antenna or the antenna element, or adjust a radiation pattern of the antenna or the antenna element.

In some examples, the selection of the at least one wireless communication parameter for the first transmission based on the at least one parameter of the first parameter set may include identification of a set of requirements for ensuring wireless communication coexistence on a wireless communication spectrum shared with at least one second wireless communication device. In some examples, the second wireless communication device may include a satellite, a customer premises equipment, or a relay device.

In some examples, the first wireless communication device may include a network entity (e.g., a gNB) or a customer premises equipment.

FIG. 21 is a flow chart illustrating an example method 2100 for wireless communication in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the wireless communication device 1900 illustrated in FIG. 19. In some examples, the method 2100 may be carried out by any suitable apparatus or means for carrying out the functions or algorithm described below.

At block 2102, a first wireless communication device may receive a set of time-varying coexistence constraints or a set of time-varying communication parameters. In some examples, the parameter processing circuitry 1942 together with the communication and processing circuitry 1941 and the transceiver 1910, shown and described in FIG. 19, may provide a means to receive a set of time-varying coexistence constraints or a set of time-varying communication parameters.

At optional block 2104, the first wireless communication device may derive a set of time-varying communication parameters based on the set of time-varying coexistence constraints. In some examples, the parameter processing circuitry 1942, shown and described in FIG. 19, may provide a means to derive a set of time-varying communication parameters based on the set of time-varying coexistence constraints.

At block 2106, the first wireless communication device may transmit the set of time-varying coexistence constraints or the set of time-varying communication parameters to a wireless communication device. In some examples, the coexistence processing circuitry 1943 together with the communication and processing circuitry 1941 and the transceiver 1910, shown and described in FIG. 19, may provide a means to transmit the set of time-varying coexistence constraints or the set of time-varying communication parameters to a wireless communication device.

Referring again to FIG. 19, in one configuration, the wireless communication device 1900 includes means for receiving a first message including a first parameter set and associated first time schedule, the first message indicating a mapping of each of a plurality of time periods of the first time schedule with a corresponding subset of the first parameter set, and means for transmitting a first transmission based on at least one parameter of the first parameter set. In one configuration, the wireless communication device 1900 includes means for receiving receive a set of time-varying coexistence constraints or a set of time-varying communication parameters, means for deriving a set of time-varying communication parameters based on the set of time-varying coexistence constraints, and means for transmitting the set of time-varying coexistence constraints or the set of time-varying communication parameters to a wireless communication device. In one aspect, the aforementioned means may be the processor 1904 shown in FIG. 19 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1904 is merely provided as an example, and other means for carrying out the described functions may be included within various aspects of the present disclosure, including but not limited to the instructions stored in the computer-readable medium 1906, or any other suitable apparatus or means described in any one or more of FIGS. 1-3, 5-10, 12-15, and 19, and utilizing, for example, the methods and/or algorithms described herein in relation to FIGS. 20 and 21.

The methods shown in FIGS. 17, 18, 20, and 21 may include additional aspects, such as any single aspect or any combination of aspects described below and/or in connection with one or more other processes described elsewhere herein. The following provides an overview of several aspects of the present disclosure.

Aspect 1: A method of communication at a first wireless communication device, the method comprising: receiving a first message comprising a first parameter set and associated first time schedule, the first message indicating a mapping of each of a plurality of time periods of the first time schedule with a corresponding subset of the first parameter set; and transmitting a first transmission based on at least one parameter of the first parameter set.

Aspect 2: The method of aspect 1, wherein the mapping of each of the plurality of time periods of the first time schedule with the corresponding subset of the first parameter set maps: a first time period of the plurality of time periods with a first subset of the first parameter set; and a second time period of the plurality of time periods with a second subset of the first parameter set, the second time period being different from the first time period, and the second subset being different from the first subset.

Aspect 3: The method of any of aspects 1 through 2, wherein the mapping of each of the plurality of time periods of the first time schedule with the corresponding subset of the first parameter set comprises a look-up table.

Aspect 4: The method of any of aspects 1 through 3, further comprising: receiving a second message comprising a second parameter set and associated second time schedule to at least temporarily supersede the first parameter set and the first time schedule; and transmitting a second transmission based on at least one parameter of the second parameter set.

Aspect 5: The method of aspect 4, wherein the second message further comprises an indication of a duration of time during which the second parameter set and the second time schedule are valid.

Aspect 6: The method of any of aspects 1 through 5, wherein the first parameter set comprises at least one of: a wireless communication coexistence parameter, an interference level, or an indication of a direction between the first wireless communication device and a second wireless communication device.

Aspect 7: The method of aspect 6, wherein the second wireless communication device comprises a satellite, a customer premises equipment, or a relay device.

Aspect 8: The method of any of aspects 6 through 7, wherein: the method further comprises selecting at least one wireless communication parameter for the first transmission based on the at least one parameter of the first parameter set; and the transmitting the first transmission based on the at least one parameter of the first parameter set comprises a transmission based on the at least one wireless communication parameter.

Aspect 9: The method of aspect 8, wherein the at least one wireless communication parameter indicates at least one of: a wireless communication setting, a wireless communication attribute, a beamforming mode, a beamformer, a beamforming codebook, an antenna array, antenna element tilt information, an antenna radiation pattern, a transmit power, or a bandwidth.

Aspect 10: The method of any of aspects 8 through 9, wherein the method further comprises, based on the at least one wireless communication parameter, at least one of: switching from a digital beamforming mode to an analog beamforming mode; switching from the analog beamforming mode to the digital beamforming mode; switching from a first beamforming codebook to a second beamforming codebook; switching from a first beamformer to a second beamformer; switching from a first precoder to a second precoder; adjusting a transmit power; switching from a first transmit bandwidth to a second transmit bandwidth; enabling an antenna or an antenna element; disabling the antenna or the antenna element; adjusting a tilt of the antenna or the antenna element; or adjusting a radiation pattern of the antenna or the antenna element.

Aspect 11: The method of any of aspects 8 through 10, wherein the selecting the at least one wireless communication parameter for the first transmission based on the at least one parameter of the first parameter set comprises: identifying a set of requirements for ensuring wireless communication coexistence on a wireless communication spectrum shared with at least one second wireless communication device.

Aspect 12: The method of aspect 11, wherein the second wireless communication device comprises a satellite, a customer premises equipment, or a relay device.

Aspect 13: The method of any of aspects 1 through 12, wherein the first wireless communication device comprises a network entity.

Aspect 14: The method of any of aspects 1 through 13, wherein the first wireless communication device comprises a customer premises equipment.

Aspect 15: The method of any of aspects 1 through 14, wherein the first parameter set indicates at least one of: a wireless communication setting, a wireless communication attribute, a beamforming mode, a beamformer, a beamforming codebook, an antenna array, antenna element tilt information, an antenna radiation pattern, a transmit power, or a bandwidth.

Aspect 16: The method of any of aspects 1 through 15, wherein the transmitting the first transmission based on the at least one parameter of the first parameter set comprises: transmitting at least one wireless communication parameter based on the first parameter set to at least one second wireless communication device.

Aspect 17: The method of aspect 16, wherein the at least one wireless communication parameter instructs the at least one second wireless communication device to at least one of: switch from a digital beamforming mode to an analog beamforming mode; switch from the analog beamforming mode to the digital beamforming mode; switch from a first beamforming codebook to a second beamforming codebook; switch from a first beamformer to a second beamformer; switch from a first precoder to a second precoder; adjust a transmit power; switch from a first transmit bandwidth to a second transmit bandwidth; enable an antenna or an antenna element; disable the antenna or the antenna element; adjust a tilt of the antenna or the antenna element; or adjust a radiation pattern of the antenna or the antenna element.

Aspect 18: The method of any of aspects 1 through 17, wherein the first parameter set comprises at least one of: side lobe information; satellite orientation information; or leakage constraints.

Aspect 19: The method of aspect 18, wherein the first wireless communication device comprises a customer premises equipment.

Aspect 20: The method of aspect 18, wherein the first wireless communication device comprises a relay device.

Aspect 21: A wireless communication device (e.g., network entity, a CPE, etc.) comprising: a transceiver, one or more memories storing processor-executable code, and one or more processors coupled to the transceiver and the one or more memories, wherein the one or more processors are configured to execute the processor-executable code and cause the wireless communication device to perform any one or more of aspects 1 through 12 and 15 through 18.

Aspect 22: An apparatus configured for wireless communication comprising at least one means for performing any one or more of aspects 1 through 12 and 15 through 18.

Aspect 23: A non-transitory computer-readable medium storing computer-executable code, comprising code for causing an apparatus to perform any one or more of aspects 1 through 12 and 15 through 18.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-21 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 5, 6, 7, 8, 9, 12, 13, 14, 15, 16, and 19 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first wireless communication device, comprising:
one or more memories storing processor-executable code; and
one or more processors configured to execute the processor-executable code and cause the first wireless communication device to:
receive a first message comprising a first parameter set and associated first time schedule, the first message indicating a mapping of each of a plurality of time periods of the first time schedule with a corresponding subset of the first parameter set; and
transmit a first transmission based on at least one parameter of the first parameter set.

2. The first wireless communication device of claim 1, wherein the mapping of each of the plurality of time periods of the first time schedule with the corresponding subset of the first parameter set maps:
a first time period of the plurality of time periods with a first subset of the first parameter set; and
a second time period of the plurality of time periods with a second subset of the first parameter set, the second time period being different from the first time period, and the second subset being different from the first subset.

3. The first wireless communication device of claim 1, wherein the mapping of each of the plurality of time periods of the first time schedule with the corresponding subset of the first parameter set comprises a look-up table.

4. The first wireless communication device of claim 1, wherein the one or more processors are further configured to execute the processor-executable code and cause the first wireless communication device to:
receive a second message comprising a second parameter set and associated second time schedule to at least temporarily supersede the first parameter set and the first time schedule; and
transmit a second transmission based on at least one parameter of the second parameter set.

5. The first wireless communication device of claim 4, wherein the second message further comprises an indication of a duration of time during which the second parameter set and the second time schedule are valid.

6. The first wireless communication device of claim 1, wherein the first parameter set comprises at least one of: a wireless communication coexistence parameter, an interference level, or an indication of a direction between the first wireless communication device and a second wireless communication device.

7. The first wireless communication device of claim 6, wherein the second wireless communication device comprises a satellite, a customer premises equipment, or a relay device.

8. The first wireless communication device of claim 6, wherein the one or more processors are further configured to execute the processor-executable code and cause the first wireless communication device to:
select at least one wireless communication parameter for the first transmission based on the at least one parameter of the first parameter set,
wherein the transmission of the first transmission based on the at least one parameter of the first parameter set comprises a transmission based on the at least one wireless communication parameter.

9. The first wireless communication device of claim 8, wherein the at least one wireless communication parameter indicates at least one of: a wireless communication setting, a wireless communication attribute, a beamforming mode, a beamformer, a beamforming codebook, an antenna array, antenna element tilt information, an antenna radiation pattern, a transmit power, or a bandwidth.

10. The first wireless communication device of claim 8, wherein, based on the at least one wireless communication parameter, the one or more processors are further configured to execute the processor-executable code and cause the first wireless communication device to at least one of:
switch from a digital beamforming mode to an analog beamforming mode;
switch from the analog beamforming mode to the digital beamforming mode;
switch from a first beamforming codebook to a second beamforming codebook;
switch from a first beamformer to a second beamformer;
switch from a first precoder to a second precoder;
adjust a transmit power;
switch from a first transmit bandwidth to a second transmit bandwidth;
enable an antenna or an antenna element;
disable the antenna or the antenna element;
adjust a tilt of the antenna or the antenna element; or
adjust a radiation pattern of the antenna or the antenna element.

11. The first wireless communication device of claim 8, wherein the selection of the at least one wireless communication parameter for the first transmission based on the at least one parameter of the first parameter set comprises:
identification of a set of requirements for ensuring wireless communication coexistence on a wireless communication spectrum shared with at least one second wireless communication device.

12. The first wireless communication device of claim 11, wherein the second wireless communication device comprises a satellite, a customer premises equipment, or a relay device.

13. The first wireless communication device of claim 1, wherein the first wireless communication device comprises a network entity or a customer premises equipment.

14. A method of communication at a first wireless communication device, the method comprising:
receiving a first message comprising a first parameter set and associated first time schedule, the first message indicating a mapping of each of a plurality of time periods of the first time schedule with a corresponding subset of the first parameter set; and
transmitting a first transmission based on at least one parameter of the first parameter set.

15. The method of claim 14, wherein the first parameter set indicates at least one of: a wireless communication setting, a wireless communication attribute, a beamforming mode, a beamformer, a beamforming codebook, an antenna array, antenna element tilt information, an antenna radiation pattern, a transmit power, or a bandwidth.

16. The method of claim 14, wherein the transmitting the first transmission based on the at least one parameter of the first parameter set comprises:
transmitting at least one wireless communication parameter based on the first parameter set to at least one second wireless communication device.

17. The method of claim 16, wherein the at least one wireless communication parameter instructs the at least one second wireless communication device to at least one of:
switch from a digital beamforming mode to an analog beamforming mode;
switch from the analog beamforming mode to the digital beamforming mode;
switch from a first beamforming codebook to a second beamforming codebook;
switch from a first beamformer to a second beamformer;
switch from a first precoder to a second precoder;
adjust a transmit power;
switch from a first transmit bandwidth to a second transmit bandwidth;
enable an antenna or an antenna element;
disable the antenna or the antenna element;
adjust a tilt of the antenna or the antenna element; or
adjust a radiation pattern of the antenna or the antenna element.

18. The method of claim 14, wherein the first parameter set comprises at least one of:
side lobe information;
satellite orientation information; or
leakage constraints.

19. The method of claim 18, wherein the first wireless communication device comprises a customer premises equipment or a relay device.

20. A first wireless communication device, comprising:
means for receiving a first message comprising a first parameter set and associated first time schedule, the first message indicating a mapping of each of a plurality of time periods of the first time schedule with a corresponding subset of the first parameter set; and
means for transmitting a first transmission based on at least one parameter of the first parameter set.
